(19) United States
(12) Patent Application Publication
(10) Pub. No.: US 2022/0327251 A1
(43) Pub. Date: Oct. 13, 2022

(54) SYSTEMS AND METHODS FOR DESIGNING AND MANUFACTURING RADIO FREQUENCY DEVICES

(71) Applicant: 3DFortify Inc., Boston, MA (US)

(72) Inventors: Philip Michael Lambert, Cambridge, MA (US); Daniel T. Shores, Medford, MA (US); Joshua J. Martin, Melrose, MA (US); G. Karlo Delos Reyes, Somerville, MA (US); Alan Charles Cramer, Lynnfield, MA (US)

(21) Appl. No.: 17/720,277

(22) Filed: Apr. 13, 2022

Related U.S. Application Data
(60) Provisional application No. 63/174,519, filed on Apr. 13, 2021.

(51) Int. Cl. G06F 30/12; G06F 30/17

(52) U.S. Cl. CPC G06F 30/12; G06F 30/17; G06F 2113/10

(57) ABSTRACT

Methods and systems for designing and manufacturing RF devices is provided. The disclosed methods allow for quick and efficient printing without having to generate a CAD file or the like to generate the build file. This can be achieved by receiving RF inputs, such as inputs generated from an RF simulation, and combining that with geometry design data, such as boundary geometry information that can include an outer geometry and size of the device to be printed. Further, the RF devices that are produced can use triply periodic minimal surface constructs as the base element of the device.

### CROSS-REFERENCED TO RELATED APPLICATIONS

This application claims the benefit of U.S. Provisional Application No. 63/174,519, filed on Apr. 13, 2021, and entitled “Systems and Methods for Designing and Manufacturing Radio Frequency Devices,” the entire content of which is hereby incorporated by reference in its entirety.

### FIELD

The present disclosure relates to system and methods for designing and manufacturing radio frequency (RF) devices, such as gradient indexed (GRIN) lenses, for production using additive manufacturing techniques, and more particularly relates to processing RF inputs, such as those produced through a simulation, to produce a print file that can be used without any intermediate steps like mesh generation (e.g., .STL, .STEP, .3MF, .AMF, and .IGES files). The present disclosure also relates to systems and methods that result in the production of RF devices, such as GRIN lenses, that include triply periodic minimal surfaces (TPMS, or referred to as TPMSs typically when plural), such as gyroids, as well as the GRIN lenses that include TPMSs themselves.

### BACKGROUND

3D printing, or additive manufacturing (AM), includes the construction of a three-dimensional object from a CAD model or a digital 3D model. The 3D object can be virtually any object, including but not limited to RF devices. Various 3D printing techniques exist to produce such 3D objects. Currently, the systems for printing RF devices blend material with air to create a tailored effective dielectric constant. These devices, for example, a graded refractive index (GRIN) lens, can be manufactured through a variety of 3D printing processes in a variety of geometries. There are a variety of methods that are employed to achieve the gradient index of refraction in a GRIN device design. One such method is the core-shell method, which is a manufacturing and assembly process that requires the manufacturer to fabricate and assemble a series of nested shells made from discrete dielectric materials. In another process, rather than nested shells, the design utilizes shells assembled from wedges of dielectric material. Still another method is the drill-hole method, which is a process where the manufacturer drills holes of varying sizes and spacing into a bulk dielectric material. A further method utilizes a tapered rod, which is thinner on one end and thicker on the other, and the rods are assembled in a manner to create a gradient index lens.

Another method to achieve a tailored dielectric constant is to utilize a lattice structure where unit cells of a specific, constant geometry (such as an octet unit cell) are repeated within a boundary. These unit cells are comprised of a series of struts and nodes, populating a cubic or cuboid space. The boundary defines the outer geometry or shape of the device and is often spherical or hemispherical. When a strut-and-node type lattice comprised of cubic or cuboid unit cells (like the octet) is bisected by a spherical boundary, the resultant geometry will have high aspect ratio beams extending into space unreinforced by another node. However, these cantilever beams have a high likelihood of cracking or breaking off the device when the device is handled or agitated. Further, they are also far less likely to survive the printing and post processing steps. In all these methods, the goal is to manufacture a device with varying effective dielectric properties across the part. These methods have been identified by industry and technology experts as inadequate in their performance, as well as challenging and expensive to manufacture.

Another challenge in printing process of RF devices are the requirement of complex simulation and design techniques that require high amounts of compute power and/or a complicated workflow. The current software workflows for designing these geometries typically involve computer-aided design packages that represent the RF design as an .STL or .STEP file, which require high amounts of compute power.

FIG. 1 illustrates a workflow 10 commonly utilized to get from an RF device design step 12 to a printed part, formed from a build file created at a build file generation step 16. The design process can start by determining or otherwise obtaining desired RF parameters for an RF device (e.g., an RF GRIN lens). Some exemplary RF parameters can include, by way of non-limiting examples, effective permittivity, permittivity distribution, etc. Determining or otherwise obtaining such parameters can be performed by an RF engineer and/or they can be determined or otherwise obtained from another source, such as a third party or some automated process. The parameters can then be provided to perform the RF device design step 12, transforming the exemplary RF parameters into design data or information 13 for use further in the workflow 10. This transformation can be performed, for example, by an RF engineer using programs like Ansys high-frequency structure simulator (HFSS), COMSOL RF, Simulia CST Studio, and/or Matlab. In alternative embodiments, the transformation can be automated by virtue of having a processor to receive and perform the generation of the design data 13 from the inputted parameters.

After the design data 13 has been generated, it can be passed to an RF geometry design step 14. The design data 13 is combined with information about a geometric design of the desired RF device to be printed. The geometric design information can be provided by any source, including users, engineers, other people, a computer system, tables, and/or other sources. The RF geometry design step (e.g., RF GRIN geometry step) 14 involves this combination of data 13 and geometric design information. The step 14 can be performed by a design engineer and/or it can be automated, similar to the possible automation of step 12. As shown, additional software can be operated in the RF geometry design step 14, the software including parametric modeling software and/or generative design software, as well as other software known to those skilled in the art and/or custom designed software solutions. The output of the step 14 is a large, CAD file, typically including complex lattice structures included as part of a 3D model that is based on the design data 14 and the geometric design information. Some non-limiting embodiments of such files include an “.STL” file format 15, as shown in FIG. 1, and a “.STEP” file format. This large CAD file will be passed to a printer for printing. By passing design information 13 through common CAD file types (e.g., .STL files, .STEP files, others known to those skilled in the art), the user is required to represent their complex lattice structure as a 3D model. These lattice models can get created unmanageably large file formats (e.g., the .STL file format 15) very quickly, e.g., on the order of gigabytes for large parts (6″ hemisphere, for example), which is not typically considered a reasonable file size for any industry-standard CAD package or 3D printer build processing software. There is also a very critical trade-off between file size and file resolution. FIG. 2 illustrates how resolution can impact file size of a small device, provided in this example as a 65 mm sphere. As shown, the resolution of 500 micron struts for a 65 mm diameter RF lens varies for different file sizes, as shown file sizes of 450 megabytes (MB), 275 MB, and 198 MB, with resolution getting progressively worse as file size decreases.

Under existing techniques, the large file(s), e.g., the .STL file format 15, is passed to the build file generation step 16. This step 16 can be performed by a print engineer and/or it can be automated, similar to the possible automation of steps 12 and 14. The 3D printer can use a variety of software, including but not limited to Netfabb and/or Magics, as well as other software known to those skilled in the art and/or other printer-specific software, to turn the .STL file format 15 into a print job. The print job can be performed, resulting in a printed part, such as an RF GRIN lens. However, the processing challenge afforded by current techniques extends to generating a print file. Slicing a 6″ hemisphere to create images for a digital light printer (DLP) build file can take an undesirable amount of time—in some instances as long as five days even on a high performance personal computer (PC).

One technique for manufacturing a GRIN lens is through a core-shell method. However, one inadequacy in this method is that there is often an air gap between each concentric shell of the part. This air gap disrupts the intended gradient from one dielectric material to another, causing the dielectric constant gradient to have intermittent interruptions equal to the dielectric constant of air. These air gap inclusions are known to dramatically impact the performance of the lens. FIGS. 3A-3B illustrate existing implementations of lattice-based GRIN device 50, 150 approaches. More specifically, FIG. 3A is a spherical lattice-based lens design, as shown a Luneburg Lens 50, which is a type of lens known to those skilled in the art, where any beams with only one node connection point is removed. FIG. 3B illustrates the same design of a Luneburg Lens 150, but cut to the intended spherical boundary, leaving behind many free-standing cantilever beams 152. In both FIGS. 3A-3B, the sphere of the lens 50, 150 defines the intended boundary geometry. The designer can either sacrifice on the shape of the lens boundary, or he or she can build a device with a surface of weak cantilevered beams.

Other fabrication challenges are illustrated with respect to design files 60, 160 of Luneburg Lenses in FIGS. 4A-4B, respectively, with FIG. 4C showing a close-up section of a surface 62 of the spherical boundary of the lattice structure of FIG. 4B. More particularly, FIGS. 4A-4B show two unfavorable lattice conditions for the design files 60, 160, while FIG. 4C illustrates a section of the spherical boundary in which fully and partially formed struts 64a extend into space while other struts 64b are bisected along their axes. In both FIGS. 4A and 4B, an intended spherical boundary 61, 161 illustrates a desired boundary for the respective lens were an ideal configuration be achievable. As shown in FIGS. 4A and 4C, one condition shows struts 64a extend into free space from a respective node 66 due to any beams or struts 64a with only one node connecting point being removed, and another condition shows struts 64b bisected along their length, failing to reach their full radius. Alternatively, when cutting to the intended spherical boundary 161 as shown in FIG. 4B, many free-standing cantilever beams 164 can be created. By using this cuboid unit cell strut-and-node approach in FIGS. 4A and 4B, the designers of lattice-based GRIN lenses generated from the design files 60, 160, are left to decide between two choices: 1) to digitally remove cantilever struts from the design, allowing only full unit cells to remain part of the design, but sacrifice on the overall shape of the device (as shown, in FIGS. 4A and 4B, the struts 64a, 64b and 164 sometimes go past the intended spherical boundary 61, 161 while in other instances the struts 64a, 64b and 164 fall short of the intended spherical boundary 61, 161); or 2) to have the surface/boundary of the device consist of high aspect ratio, fragile struts while closely matching the intended boundary.

In the first case, illustrated in FIG. 4A, material is removed from parts of the device in the design file 60 near the surface 62. When that material is removed from the design, the outer boundary or shape of the device in the design file 60 is changed (in this case) from a smooth sphere to a blocky stair-stepped boundary 68. This boundary shape change can have detrimental impacts to the overall performance of the resulting device that is printed based on the design file 60, particularly if the device is an RF device, such as radio frequency lensing applications. When considering an RF lens device, the overall gain of the device can be an important performance attribute or parameter. The gain combines the directivity of the antenna and the radiation efficiency of the antenna. For a transmitting antenna, the value of the gain informs how well the antenna converts input power into radio waves headed in a specified direction, while for a receiving antenna the gain informs how well the antenna converts radio waves arriving from a specified direction into electrical power. The overall gain of the device is tied to its aperture size, with antenna having large effective apertures typically having higher gain. Thus, the blocky stair-stepped boundary 68 result, among other problems with existing techniques (e.g., over-curing, under-curing) discussed herein or otherwise understood by those skilled in the art, negatively impacts the overall gain of the to-be-printed device.

In the second case, illustrated in FIG. 4B, the device that results from the design file 160 more closely matches its intended design, yet the component is: (1) less likely to fully print without failures; (2) less likely to survive post processing steps; (3) less likely to survive handling by a technician; (4) less likely to survive inspection or measurement steps with calipers; (5) less likely to survive shipping; (6) less likely to survive being installed into its final package; and/or (7) less likely to remain intact throughout its lifetime of operation. This is at least because the second case results in less complete and/or less sturdy print jobs, resulting in more fragile printed objects.

One option to combat the fragile strut challenge is to print with a stronger and tougher material. The material used in the GRIN device design should be a dielectric (an electrical insulator) to function as a GRIN device, typically precluding the usage of metallic materials as the base material in the design. Ceramics or glasses are dielectric materials, yet they can exhibit similar brittleness as plastics with features manufactured at these scale sizes. There are tougher and stronger plastics available for 3D printing, but material selection can be a complex web balancing between a variety of factors, including but not limited to the dielectric characteristics of the material, the mechanical properties of the material, the resolution of the printing process, and/or the speed and/or economics of the printing process.

In most, if not all, of these situations, the features have limited structural integrity and introduce a high risk of failure. Even in the case where an idealized GRIN lens (e.g., a Luneburg Lens) can be manufactured with the appropriate tolerance such that no air gap exists, the resulting lens does not have a desirable peak performance. For example, a GRIN lens having no air gap between each shell when printed using the core-shell approaching with nested shells still discretizes each shell of the lens to a single, individual dielectric constant. This means that the resultant lens can never achieve a true continuous gradient. It is possible to reduce the jump in dielectric constant from one shell to another by reducing the thickness of each shell, but this will substantially increase device complexity and manufacturing costs, and yet still never realize a continuous gradient. It is currently a challenge to manufacture a part that has varying dielectric properties across the part while maintaining a desired geometry for that part. This challenge is particularly acute when trying to use 3D printing techniques to manufacture RF devices, such as GRIN lenses.

The problems that required attention in view of the current state of the art are at least two-fold: (1) a need for improved device design and manufacture; and (2) a need for improved 3D printed device design workflow. More particularly, there is a need for systems and methods to produce a 3D device (e.g., an RF lens) quickly, with the resulting device having low structural risks, meeting the design intent, and being constructed to have more suitable dielectric properties across the resulting device.

### SUMMARY

The present systems and methods described herein allows for users to strictly define the desired device properties (e.g., RF properties) for a given area (e.g., by explicit equation and/or by including simulation data from other RF software such as high-frequency structure simulator (HFSS) or CST Studio Suite®) and receive a part geometry that is optimized both for manufacturability and RF performance. The methods for designing and manufacturing devices (e.g., GRIN lenses) allow for the device to have specific RF properties at specific locations within the build. The properties can be defined, for example, by an implicit equation and/or by a detailed description of device properties (e.g., RF properties, such a dielectric constant) as a function of three-dimensional space. With reference to FIG. 1, the present disclosure allows for the RF GRIN Geometry step 14 to be bypassed or otherwise eliminated (i.e., there is no need for files like .STL files or .STEP files, among other similar or equivalent file types as known to those skilled in the art), thus eliminating the need for a large file for printing, among other benefits described in greater detail herein. Instead the present disclosures allow a user, or a system operating the method, to go directly from a simulated RF design (or other RF design as inputted or otherwise designed) and corresponding boundary representation to a printable file with machine instructions. By bypassing the necessity to realize the design as a CAD file, it is possible to not only simplify, but also significantly streamline, the Design-to-Print workflow for generating GRIN devices and other 3D-printed structures. In addition to streamlining the design process, the present disclosures allow for several individual lattice and TPMS geometries to be used, allowing for more reliable parts that print faster and are easier to post process than competitive structures.

Specifically, the present disclosure describes methods for designing and manufacturing RF devices in a way that the part designer uses a triply periodic minimal surface construct as the base element. In place of the octet unit cell, a TPMS geometry like a gyroid can be utilized in a GRIN device to produce the tailored dielectric constant. The gyroid construct includes surface features that are self-supporting. When the gyroid is bisected, the geometry does not generate weak cantilevered beams and the resulting device is more robust than its strut-and-node counterparts. The TPMS GRIN lens can be printed, post processed, and handled with significantly reduced likelihood of experiencing damage. The increased robustness of the design also allows devices to be produced with faster print speeds.

In one exemplary method of designing and/or manufacturing a radio frequency (RF) device by way of additive manufacturing, the method includes receiving a plurality of inputs, with the inputs including both a plurality of RF inputs and at least one of: (1) a desired boundary shape of a planned RF device to be printed; (2) a selection of one or more materials for printing; and/or (3) a selection of one or more unit cells to be generated when printing. The method further includes converting the plurality of RF inputs to one or more geometric-defining property values, and determining one or more geometric-defining property values across a volume of the planned RF device to be printed.

In some embodiments, the plurality of RF inputs can include a plurality of dielectric constant values in three-dimensional space. In some such embodiments, the method can be performed in a manner such that no bounding geometry is utilized in conjunction with the plurality of dielectric constant values in three-dimensional space. Additionally, or alternatively, the method can be performed in a manner such that no lattice is graphically rendered from the plurality of dielectric constant values in three-dimensional space.

The one or more geometric-defining property values can include at least one of a unit cell density, a wall thickness, or a struck thickness. The action of determining one or more geometric-defining property values across a volume of a planned RF device to be printed can further include creating a gradient of the one or more geometric-defining property values across a volume of a planned RF device to be printed. Additionally, or alternatively, the action of determining one or more geometric-defining property values across a volume of a planned RF device to be printed can include interpolating the one or more geometric-defining property values for each unit cell, or part of the unit cell, of the planned RF device to be printed. Still further, in at least some embodiments, the action of determining one or more geometric-defining property values across a volume of a planned RF device to be printed can include identifying a nearest data value to each unit cell and assigning, based on the identified nearest data value, the one or more geometric-defining property values for each unit cell, or part of the unit cell, of the planned RF device to be printed.

The method can further include generating each layer slice for printing the planned RF device to be printed. The method can also include exporting a print file that includes each layer slice for printing the planned RF device to be printed. In at least some embodiments, the method can include printing the planned RF device to be printed.

In some embodiments the method can include performing a radio frequency simulation to obtain the plurality of RF inputs and/or using one or more equations to determine the plurality of RF inputs. The plurality of RF inputs can include: (1) a plurality of shells, the shells having different permittivity values; (2) a point cloud of RF data points, the RF data points having different permittivity values across the cloud; or (3) values derived from one or more equations to determining permittivity values, the permittivity values differing across a provided geometry.

The actions performed in the method can be performed without generating a mesh. Accordingly, in at least some embodiments, the method can be performed without generating a CAD file. Such a CAD file can include at least one of an .STL file, a .STEP file, a .3MF file, an .AMF file, or an .IGES file.

One exemplary method of designing and/or manufacturing a radio frequency (RF) device includes receiving a plurality of inputs, with the inputs including both a plurality of RF inputs and at least one of: (1) a desired boundary solid geometry; (2) a selection of one or more materials for printing; and/or (3) a selection of one or more unit cells to be generated when printing. The method further includes determining at least one of a density or a strut thickness for each unit cell, or part of a unit cell, of a planned RF device to be printed, creating a set of layer masks that include lattice geometry information for each layer slice of the planned RF device to be printed based on the determined density and/or strut thickness, and slicing a boundary solid geometry and combining at least some portion of the set of layer masks to the sliced boundary solid geometry to create a final slice to be printed.

The method can further include exporting a print file that includes each layer slice for printing the planned RF device to be printed. The method can include printing the planned RF device to be printed. In at least some embodiments, the method can include performing a radio frequency simulation to obtain the plurality of RF inputs and/or using one or more equations to determine the plurality of RF inputs. The plurality of RF inputs can include: (1) a plurality of shells, the shells having different permittivity values; (2) a point cloud of RF data points, the RF data points having different permittivity values across the cloud; or (3) values derived from one or more equations to determining permittivity values, the permittivity values differing across a provided geometry.

The lattice geometry information for each layer slice of the planned RF device to be printed can include at least one of: unit cell size, unit cell type, a grid phase, or density from a dielectric constant input. The actions of the method can be performed without generating a mesh. Accordingly, in at least some embodiments, the method can be performed without generating a CAD file. Such a CAD file can include at least one of an .STL file, a .STEP file, a .3MF file, an .AMF file, or an .IGES file.

Another method of designing and/or manufacturing a radio frequency (RF) device includes receiving a plurality of design inputs for an RF device to be printed. The inputs include at least two of: (a) a desired design type; (b) a weight; (c) a boundary; (d) a size; (e) an aperture size; (f) a gain; (g) a frequency of operation; and/or (h) a focal distance from a surface to a center. The method further includes suggesting a design output for the RF device to be printed based at least on the received plurality of design inputs.

The desired design type can include at least one of a Luneburg lens, a Luneburg-style lends, or a Gutman lens. The design output can include at least one of: (1) a dielectric constant distribution; (2) at least one of a lattice structure selection or a triply periodic minimal surface (TPMS) structure selection; or (3) one or more support structures. In at least some such embodiments, the design output can further include a device size and/or a device boundary.

The actions performed in the method can be performed without obtaining RF inputs. Additionally, or alternatively, the actions in the method can be performed without generating a mesh. Accordingly, in at least some embodiments, the method can be performed without generating a CAD file. Such a CAD file can include at least one of an .STL file, a .STEP file, a .3MF file, an .AMF file, or an .IGES file.

One exemplary embodiment of a gradient refractive index (GRIN) device includes a plurality of triply periodic minimal surface (TPMS) constructs and one or more materials having a tailored dielectric constant.

The plurality of TPMS constructs can include one or more gyroids. The plurality of TPMS constructs can form a plurality of unit cells. A wall thickness of at least one TPMS construct of the plurality of TPMS constructs can have a changing thickness across its length. Further, in at least some embodiments, a wall thickness of the plurality of TPMS constructs can change across a length of the GRIN device. The GRIN device can include a lens.

One exemplary method of manufacturing a gradient refractive index (GRIN) device can include forming a plurality of triply periodic minimal surface (TPMS) constructs from one or more materials to form a GRIN device having a tailored dielectric constant throughout its volume.

In at least some embodiments, the method can include controlling a thickness of one or more walls of the plurality of TPMS constructs to control a density of the plurality of TPMS constructs. The plurality of TPMS constructs can form a plurality of unit cells. In some such embodiments, controlling a thickness of one or more walls of the plurality of TPMS constructs can control a density of the plurality of unit cells.

The method can also include comparing parameters in at least one of an x, y, or z position in Cartesian space within the plurality of TPMS constructs and/or the plurality of unit cells with a pre-determined coefficient based on a desired density of at least one of the plurality of TPMS constructs or the plurality of unit cells. In at least some such embodiments, the method can include determining the pre-determined co-efficient. This can occur by generating a collection of at least one of TPMS constructs or unit cells within a range of coefficient values, calculating a density as volume of solid divided by total volume for each TPMS construct and/or unit cell of the collection, and using the calculated densities in a piecewise linear interpolation equation to compare any desired density against.

Any of the features or variations described herein can be applied to any particular aspect or embodiment of the present disclosure in a number of different combinations. The absence of explicit recitation of any particular combination is typically for brevity, avoiding unnecessary length or repetition.

### BRIEF DESCRIPTION OF DRAWINGS

This disclosure will be more fully understood from the following detailed description taken in conjunction with the accompanying drawings, in which:

FIG. 1 is a flow diagram for designing and generating a build file for use in 3D printing an RF GRIN lens in the prior art;

FIG. 2 illustrates three images of a same portion of struts of an RF lens, each image having a different resolution;

FIG. 3A is a front perspective view of one embodiment of a Luneburg lens as produced using printing techniques known in the art;

FIG. 3B is a perspective view of another embodiment of a Luneburg lens as produced using printing techniques known in the art;

FIG. 4A is a top view of a spherical lattice-based Luneburg lens design in which any beam with only one node connection point is removed;

FIG. 4B is a top view of a spherical lattice-based Luneburg lens design in which beams are cut to the intended spherical boundary, leaving behind many free-standing cantilever beams;

FIG. 4C is a detailed top view of a section of the spherical lattice-based Luneburg lens design of FIG. 4A;

FIG. 5 is a schematic top view of a spherical Luneburg lens demonstrating transmission and bending of RF energy;

FIG. 6 is a top view of a spherical lattice-based Luneburg lens design in which struts are filtered from a spherical surface and only beams that have more than one contact point are left to define a boundary thereof;

FIG. 7A is a perspective view of one exemplary embodiment of a unit cell that includes TPMSs, as shown an inverse walled gyroid design;

FIG. 7B is a perspective view of another exemplary embodiment of a unit cell that includes TPMSs, as shown a walled gyroid design;

FIG. 7C is a perspective view of still another exemplary embodiment of a unit cell that includes TPMSs, as shown a walled Schwarz P design;

FIG. 7D is a perspective view of another exemplary embodiment of a unit cell that includes TPMSs, as shown a walled SplitP design;

FIG. 7E is a perspective view of yet another exemplary embodiment of a unit cell that includes TPMSs, as shown a walled diamond design;

FIG. 7F is a perspective view of one exemplary embodiment of a unit cell that includes a strut and node type design, as shown a cubic design;

FIG. 7G is a perspective view of another exemplary embodiment of a unit cell that includes a strut and node type design, as shown a Kelvin design;

FIG. 7H is a perspective view of still another exemplary embodiment of a unit cell that includes a strut and node type design, as shown an Octet design;

FIG. 7I is a perspective view of another exemplary embodiment of a unit cell that includes a strut and node type design, as shown a body centered cubic design;

FIG. 7J is a perspective view of yet another exemplary embodiment of a unit cell that includes a strut and node type design, as shown a faced centered cubic design;

FIG. 8A is a top view of a spherical Luneburg lens design modeled from the inverse walled gyroid of FIG. 7A;

FIG. 8B is a top view of a spherical Luneburg lens design modeled from the walled gyroid of FIG. 7B;

FIG. 8C is a top view of a spherical Luneburg lens design modeled from the walled Schwarz P of FIG. 7C;

FIG. 8D is a top view of a spherical Luneburg lens design modeled from the walled SplitP of FIG. 7D;

FIG. 9 is a top view of the spherical Luneburg lens design of FIG. 8B overlaid on the schematic top view of the spherical Luneburg lens schematic top view of FIG. 5;

FIG. 10A is the detailed top view of the boundary of the octet Luneburg lens with supported beams;

FIG. 10B is a detailed top view of a boundary of an octet Luneburg lens of FIG. 10A with the unsupported beams removed;

FIG. 10C is a detailed top view of a boundary of the spherical Luneburg lens of FIG. 8B;

FIG. 11A is a flow diagram of one exemplary embodiment for designing and generating a build file for use in 3D printing an RF lens;

FIG. 11B is a flow diagram of another exemplary embodiment for designing and generating a build file for use in 3D printing an RF lens;

FIG. 12A illustrates exemplary RF data that can be used to produce a spherical shell boundary;

FIG. 12B is a schematic side view of a part of the spherical shell boundary created from the RF data of FIG. 12A;

FIG. 12C is a perspective view of one exemplary embodiment of data received regarding a desired lens shape or structure, the data including a CAD file design of the structure and the data including point cloud data;

FIG. 12D is a side view of another exemplary embodiment of data received regarding a desired lens shape or structure, the data including an .STL file design of the structure and the data including point cloud data;

FIG. 13A is a perspective view of one exemplary embodiment of a unit cell having varying strut thickness that create smooth transitions across the unit cell, the unit cell including TPMSs, as shown a walled gyroid design;

FIG. 13B is a top view of the unit cell of FIG. 13A;

FIG. 13C is a perspective side view of another exemplary embodiment of a unit cell having varying strut thickness that creates smooth transitions across the unit cell, the unit cell including a strut and node type design, as shown an Octet design;

FIG. 13D is a top view of the unit cell of FIG. 13D;

FIG. 14A is a simulation graph of a density field of one embodiment of a spherical Luneburg lens to be printed, the density field being illustrated as an arbitrary grid configuration;

FIG. 14B is a simulation graph of a density field of another embodiment of a spherical Luneburg lens to be printed, the density field being illustrated as a regular grid configuration;

FIG. 15 is a graph illustrating a relationship between air fraction to effective permittivity for RF data;

FIG. 16A is a screenshot of a user interface for inputting information about an object to be printed, the screenshot illustrating options for setting a boundary geometry for the object to be printed;

FIG. 16B is a screenshot of the user interface of FIG. 16A after sphere has been selected as the boundary geometry;

FIG. 16C is a screenshot of the user interface of FIG. 16A, the screenshot illustrating options for setting a unit cell for the object to be printed;

FIG. 16D is a screenshot of the user interface of FIG. 16C after gyroid has been selected as the unit cell;

FIG. 17A is a graph illustrating one exemplary embodiment of correlation curves that correlate permittivity to wall thickness for a 10 mm cubic walled gyroid unit cell size;

FIG. 17B is a graph illustrating another exemplary embodiment of correlation curves that correlate permittivity to strut thickness for a 12.5 mm cubic walled gyroid unit cell size;

FIG. 17C is a graph illustrating still another exemplary embodiment of correlation curves that correlate permittivity to wall thickness for a 7.5 mm cubic walled gyroid unit cell size;

FIG. 18 is a graph illustrating another exemplary embodiment of correlation curves that correlate wall thickness to permittivity for a 5 mm cubic walled gyroid unit cell size;

FIG. 19 is a graph illustrating still another exemplary embodiment of correlation curves that correlate strut thickness to permittivity for a 5 mm cubic octet unit cell size;

FIG. 20 is a graph illustrating yet another exemplary embodiment of correlation curves that correlate permittivity to strut thickness for a 5 mm cubic octet unit cell size;

FIG. 21A is a perspective cross section view of one exemplary embodiment of a lens geometry design;

FIG. 21B is the prospective view of the lens geometry design of FIG. 21A having point cloud data overlaid thereon;

FIG. 22A is a perspective view of one exemplary embodiment of support structures for supporting a lens to be printed;

FIG. 22B is a perspective view of the support structures of FIG. 22A extending from a build plate, the support structures having the lens to be printed disposed thereon;

FIG. 22C is a front view of one exemplary embodiment of an AM printer that can be used to perform the printing techniques disclosed herein;

FIG. 22D is a perspective view of components of the AM printer of FIG. 22C, the components including a reservoir, a build plate, and a light source;

FIG. 22E is a front perspective view of a plurality of GRIN lens extending from the build plate of FIG. 22D;

FIG. 23 is a perspective view of one exemplary embodiment of a layout build design image for lens to be printed, including an image of the lens of FIG. 22B and a second lens;

FIG. 24A is a top view of a sliced solid image;

FIG. 24B is a top view of a latticed Boolean layer mask;

FIG. 24C is a top view of a composite final slice to be printed;

FIG. 25 is a perspective view of sliced layers of a layout build design image;

FIG. 26 is a schematic, perspective cross section view of one exemplary embodiment of a lens geometry design having an octet strut and node structure inside and gyroid TPMS structure outside;

FIG. 27A is a front view of an octet strut and node lens geometry design and a front view of a conformal beams strut and node lens geometry design;

FIG. 27B is a front view of a lens geometry that combines the octet strut and node lens geometry design with the conformal beams strut and node lens geometry design, the octet strut and node lend geometry design being on an inside and the conformal beams strut and node lens geometry design being on an outside; and

FIG. 28 is a schematic representation of a computer system upon which the techniques described herein can be performed.

### DETAILED DESCRIPTION

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present disclosure is defined solely by the claims. The features illustrated or described in connection with one exemplary embodiment may be combined with the features of other embodiments. Such modifications and variations are intended to be included within the scope of the present disclosure. Terms commonly known to those skilled in the art may be used interchangeably herein. Further, like-numbered components and the like across embodiments generally have similar features unless otherwise stated or a person skilled in the art would appreciate differences based on the present disclosure and his/her knowledge. Still further, the present disclosure includes some illustrations and descriptions that include prototypes, bench models, or schematic illustrations. A person skilled in the art will recognize how to rely upon the present disclosure to integrate the techniques, systems, and methods provided for into a product and/or analysis method, such as a method of designing and/or manufacturing an RF device.

Because a person skilled in the art will generally understand how DLP additive manufacturing works, the present disclosure does not provide details related to the same. A person skilled in the art will understand how to apply the principles, techniques, and the like disclosed herein to DLP processes and DLP printers. Some non-limiting examples of DLP printers and techniques with which the present disclosure can be used include those provided for in U.S. Pat. No. 10,703,052, entitled “Additive Manufacturing of Discontinuous Fiber Composites Using Magnetic Fields,” U.S. Pat. No. 10,732,521, entitled “Systems and Methods for Alignment of Anisotropic Inclusions in Additive Manufacturing Processes,” and the FLUX 3D printer series, including the FLUX ONE 3D printer, manufactured by 3DFortify Inc. of Boston, Mass. (further details provided for at http://3dfortify.com/ and related web pages), the contents of all being incorporated by reference herein in their entireties.

Overview

The present systems and methods described herein allows for users to design and create build files for 3D printing a part by providing desired properties for that part (e.g., by strictly define the desired RF properties for a given area) and providing design information (e.g., geometry) for that part. The desired properties can be generated, for example, by explicit equation and/or by including simulation data from other RF software (e.g., high-frequency structure simulator (HFSS) or CST Studio Suite®). The information about part geometry can be optimized both for manufacturability and RF performance. As described herein, this allows the design process to be streamlined. Further, the present disclosure also allows for several individual lattice and TPMS geometries that can be used as unit cells to construct parts. The use of these parts, and in particular TPMS geometries, allow for more reliable parts that print faster and are easier to post process than competitive structures. Further, individual processing, such as controlling a thickness within a particular unit cell, and/or across unit cells, can provide further improvements in the printed part.

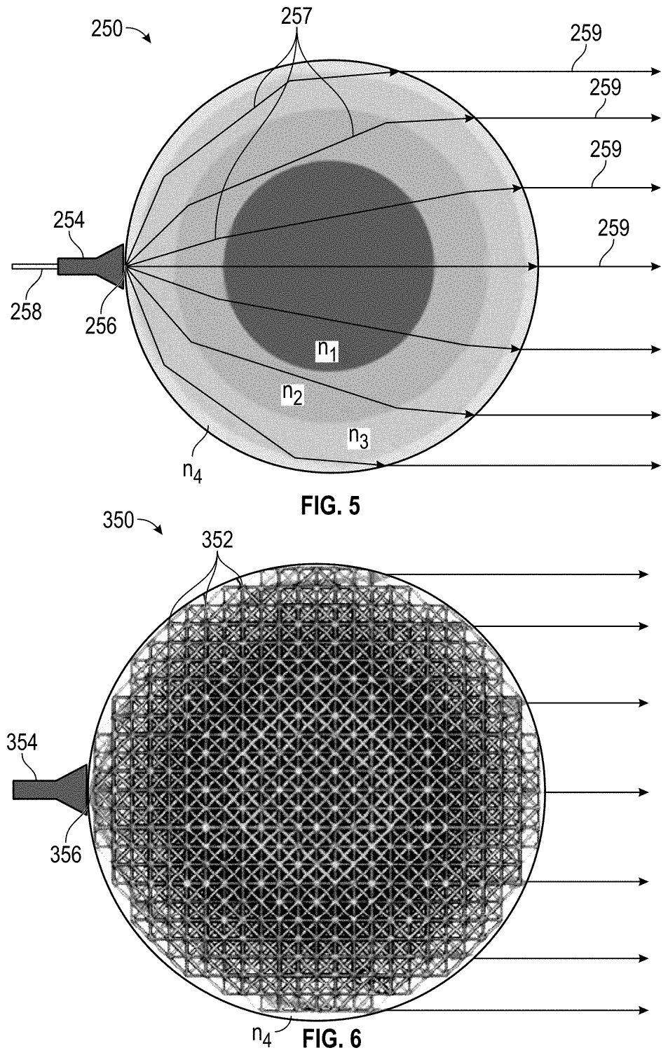

In the case of RF device performance, a typically important characteristic of an antenna device is antenna gain. Antenna gain defines the degree to which an antenna concentrates radiated power in a given direction, or absorbs incident power from that direction, compared with a reference antenna. FIG. 5 shows a schematic top view of a spherical Luneburg lens 250 demonstrating transmission and bending of RF energy. As shown, the spherical Luneburg lens 250 has four regions or shells, labeled n1 through n4, where each shell n1, n2, n3, and n4 has a unique dielectric constant value, where the highest dielectric constant is in n1, which reduces through n2 and n3, with the lowest dielectric constant in n4, as fed by an open ended wave guide antenna 254. The gain of this device 250 can be a function of the antenna aperture 256, with larger apertures typically yielding higher gains, higher gains typically being desirable. The aperture 256 can be defined as the area, oriented substantially perpendicular to the direction of an incoming electromagnetic wave 258, which can intercept the same amount of power from that wave 258 as is produced by the antenna 254 receiving it. In the case of the spherical Luneburg lens 250, the aperture 256 can be related to a diameter of the sphere that forms the outer boundary of the lens 250. When the rays 257 of RF energy enter the device 250, they can be focused into a planar wave 259 emitting from the other side of the lens 250, contributing to the overall antenna gain of the device.

FIG. 6 shows a similar illustration of a spherical Luneburg lens 350 as the lens 250 of FIG. 5, but with a lattice-based design where struts are filtered from a spherical surface of the lens 350, and only beams 352 which have more than one contact point are left to describe the boundary. Similar to the lens 250, as this device design leaves empty space at a surface of the lens 350, there is a difference between an idealized aperture size and an actual aperture size, such as for an antenna aperture 356 associated with an antenna 354. With less energy entering the device 350 from the feed source due, at least in part, to the difference in aperture size, the overall resulting antenna gain will drop, resulting in a poorer performing antenna. As a result, the device 350 may have performance and robustness problems.

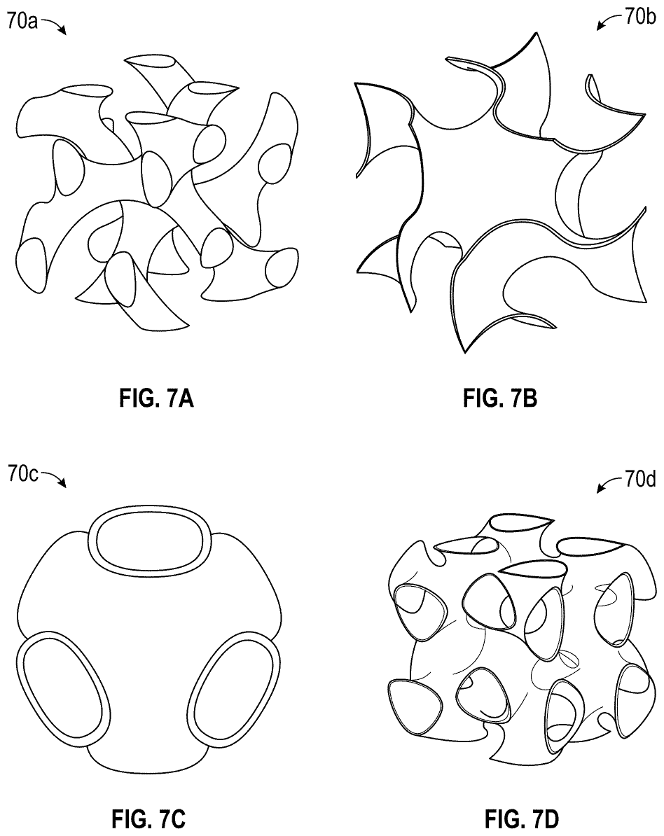

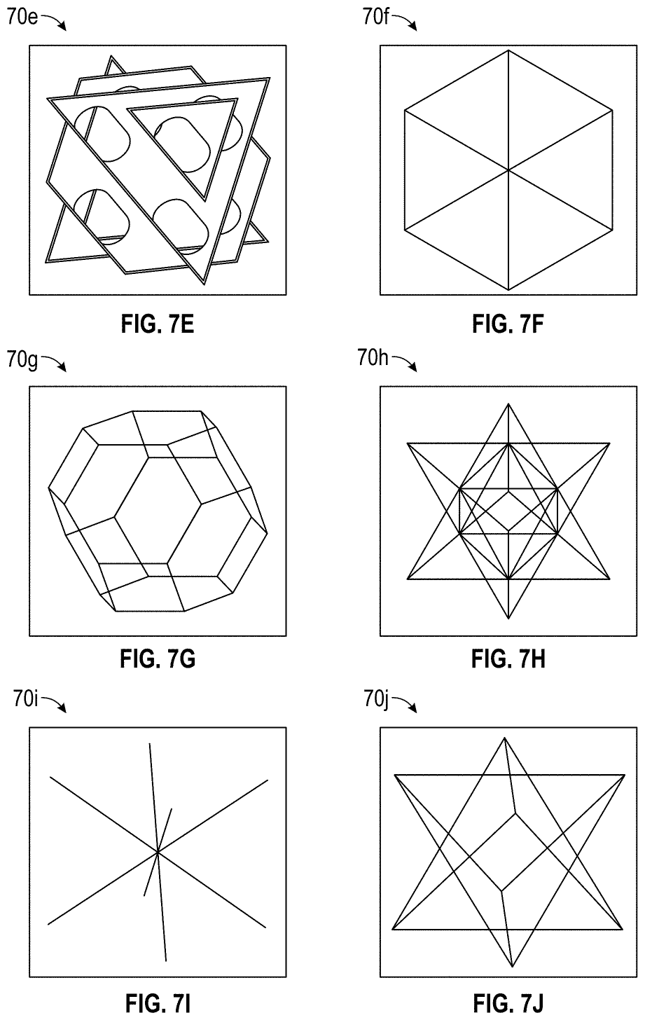

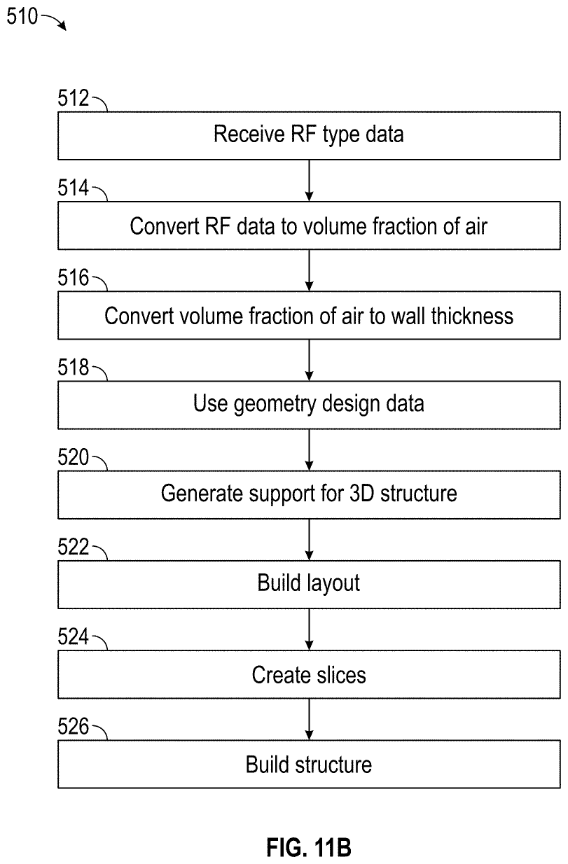

The present disclosure solves the performance and robustness problems in one instance by replacing the strut-and-node lattice geometry with triply periodic minimal surfaces (TPMSs) such that unit cells can be defined by TPMSs, and in another instance by improving the way by which the devices can be designed and printed. The use of TPMSs is described first, primarily referencing FIGS. 7A-10C, and then the methods and related systems for improved design and manufacturing is described second, primarily referencing FIGS. 11A-27. Notably, while the use of TPMSs provides advantages, as described herein, unit cells that do not incorporate TPMSs, such as unit cells that have a strut and node configuration, are permitted, and still allow for improved performance, when practicing the methods and systems described with respect to FIGS. 11A-27.

TPMS Structures for Manufacturing RF Devices

Starting first with TPMSs, a minimal surface of a TPMS is a surface that is locally area-minimizing, that is, a small piece has the smallest possible area for a surface spanning the boundary of that piece. Minimal surfaces necessarily have zero mean curvature, meaning the sum of the principal curvatures at each point is zero. Minimal surfaces that have a crystalline structure can be further beneficial at least because they repeat themselves in three dimensions, in other words being triply periodic, i.e., TPMSs.

A variety of TPMS structures that can be used in conjunction with producing devices, such as RF GRIN devices. FIGS. 7A-7E show five non-limiting unit cells having TPMS structures that can be used as unit cells for printing a device (e.g., an RF GRIN device). FIG. 7A is a unit cell 70a having a TPMS structure comprising an inverse walled gyroid design, with a gyroid being an infinitely connected periodic minimal surface containing no straight lines. FIG. 7B is a unit cell 70b having a TPMS structure comprising a walled gyroid design. FIG. 7C is a unit cell 70c having a TPMS structure comprising a walled Schwarz P design. FIG. 7D is a unit cell 70d having a TPMS structure comprising a walled SplitP design. FIG. 7E is a unit cell 70e having a TPMS structure comprising a walled diamond design.

The foregoing notwithstanding, strut and node structures can also be implemented using the provided systems and methods for producing 3D parts (e.g., an RF GRIN lens) and still obtain the benefits of the present disclosure (e.g., the systems and methods described below, such as with respect to FIGS. 11A onwards). FIGS. 7F-7J show five non-limiting strut and node structures that can be used as unit cells for printing a device (e.g., an RF GRIN device). FIG. 7F is a unit cell 70f having a strut and node structure comprising a cubic design. FIG. 7G is a unit cell 70g having a strut and node structure comprising a Kelvin design. FIG. 7H is a unit cell 70h having a strut and node structure comprising an Octet design. FIG. 7I is a unit cell 70i having a strut and node structure comprising body centered cubic design. FIG. 7J is a unit cell 70j having a strut and node structure comprising a faced centered cubic design.

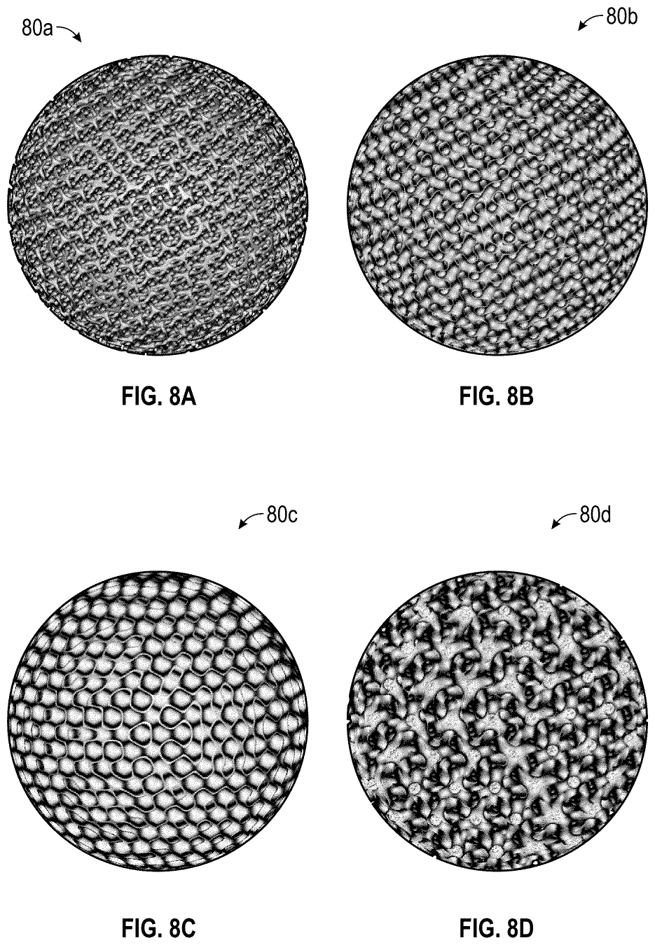

A variety of devices, such as RF GRIN devices (e.g., GRIN lenses), can be produced that are modeled from different TPMS structures. FIGS. 8A-8D show four non-limiting spherical Luneburg lenses that are produced from TPMS structures of FIGS. 7A-7D respectively. FIG. 8A is a top view of a spherical Luneburg lens design 80a modeled from the inverse walled gyroid unit cell 70a of FIG. 7A. FIG. 8B is a top view of a spherical Luneburg lens design 80b modeled from the walled gyroid unit cell 70b of FIG. 7B. FIG. 8C is a top view of a spherical Luneburg lens design 80c modeled from the walled Schwarz P unit cell 70c of FIG. 7C. FIG. 8D is a top view of a spherical Luneburg lens design 80d modeled from the walled SplitP unit cell 70d of FIG. 7D. FIGS. 8A-8D, in conjunction with the disclosures provided for herein, demonstrate that an exemplary embodiment of a GRIN device as provided for herein can include a plurality of TPMS constructs and one or more materials having a tailored dielectric constant. The present disclosure introduces the use of TPMS constructs (e.g., one or more gyroids and/or unit cells and other configurations provided for herein, including but not limited to the structures and unit cells illustrated in FIGS. 7A-7J) as unit cells in conjunction with building a GRIN device, and thus also introduces GRIN devices comprising TPMS-based unit cells.

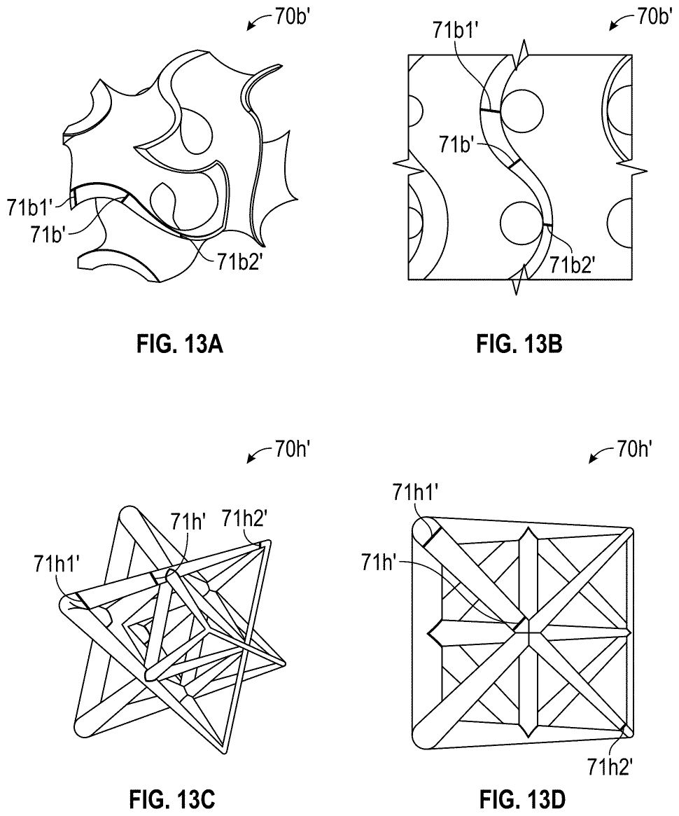

Likewise, methods for printing GRIN devices (e.g., GRIN lenses) by forming a plurality of TPMS constructs from one or more materials having a tailored dielectric constant throughout its volume is also new as compared to GRIN device printing techniques known to those skilled in the art prior to the present disclosures. Such techniques can include, as provided for herein, controlling a thickness of one or more walls of the plurality of TPMS constructs to control a density of the plurality of TPMS constructs, and/or controlling a thickness of one or more struts of a unit cell having a strut and node design to control a density of the plurality of strut and node unit cells (see FIGS. 13A-13D, and related descriptions below). Such techniques can also be applied to printing unit cells and the like provided for herein, for example those illustrated in FIGS. 7A-7J. The action of controlling a thickness of a wall and/or strut can be achieved, for example, by controlling or otherwise inputting a density of the TPMS constructs and/or unit cells. Such methods can also include comparing parameters in at least one of an x, y, or z position in Cartesian space within at least one of the plurality of TPMS constructs and/or the plurality of other unit cells with a pre-determined coefficient based, at least in part, on a desired density of at least one of the plurality of TPMS constructs and/or the plurality of unit cells. The pre-determined coefficient can be determined, for example, by generating a collection of at least one of TPMS constructs or unit cells within a range of coefficient values, calculating a density as volume of solid divided by total volume for each TPMS construct and/or unit cell of the collection, and using the calculated densities in a piecewise linear interpolation equation to compare any desired density against. A person skilled in the art will appreciate other interpolation techniques can also be employed.

GRIN devices are made of dielectric materials and have various sizes. Size is not generally a limiting factor for implementing the present disclosures. The foregoing notwithstanding, in some instances, to have an optimized performance and be robust, the desired size for these devices can be having a diameter approximately in the range of about 20 mm to about 300 mm and a volume approximately in the range of about 418 mm³ to about 14,137 cm³. These dimensions are not limiting, and devices smaller or larger than those described can be achieved, depending, at least in part, on desired size, use, dimensions of other components with which it is being used. Likewise, other, non-spherical shapes can also be achieved.

TPMS structures share the characteristic of being able to be trigonometrically defined by relatively simple equations. The equations for gyroids and Schwarz P surfaces of zero-thickness are defined below, where x, y, and z represent the position in Cartesian space within the unit cell:

### Gyroid:

sin(x)cos(y)+sin(y) cos(z)+sin(z)cos(x)=0 Eq. (1)

### P-Schwarz:

cos(x)+cos(y)+cos(z)=0 Eq. (2).

In order to express the above surfaces with thickness to become a walled structure, the left-hand side of the equation is compared to a pre-determined coefficient based on the desired density of the unit cell. The coefficient to use for a given density can be calibrated by generating a collection of unit cells within a range of coefficient values, calculating the density as volume of solid divided by total volume, and then using those values in a piecewise linear interpolation equation to compare any desired density against. Due to the surface-based nature of the TPMS structures and their self-supporting geometry, the boundary of the sphere is not populated by structurally deficient high aspect ratio beams as is the case in the strut-and-node approach. The TPMS structures provide the designer with the freedom to approximate their intended boundary geometry more closely without needing to be concerned with generating fragile species at the surface.

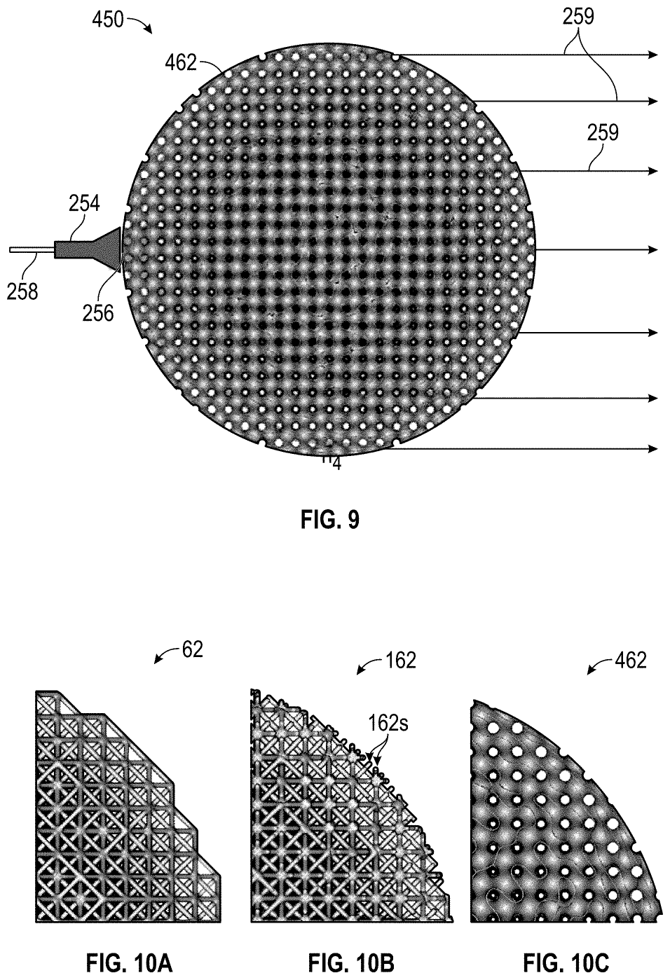

Consider FIGS. 6 and 9 to see how when a device with the same intended design is populated by a walled gyroid TPMS structure instead of an octet designed structure is able to more closely achieve the intended lens aperture design provided for in FIG. 5. As shown in FIG. 9, a walled gyroid lens 450 is overlaid on the diagram of the Luneburg lens 250. The design of the Luneburg lens 450 is similar to the design of the Luneburg lens 350 shown in FIG. 6, but the lens 450 uses walled gyroid TPMS structures instead of a lattice-based design with struts and nodes. Similar to lens 250 and 350, the gain of this device 450 can be a function of the antenna aperture 256. The aperture 256 can be defined as the area, oriented substantially perpendicular to the direction of an incoming electromagnetic wave 258, which can intercept the same amount of power from that wave 258 as is produced by the antenna 254 receiving it. The aperture 256 can be related to a diameter of the sphere that forms the outer boundary of the lens 450. When rays of RF energy (not visible, but akin to the waves 257 of FIG. 5) enter the device 450, they can be focused into a planar wave, as shown the planar wave 259 from FIG. 5, emitting from the other side of the lens 450, contributing to the overall antenna gain of the device. Because the geometry of the lens 450 more closely mimics the lens 250 of FIG. 5, the performance of the lens 450 is substantially improved as compared to the lens 350 of FIG. 6.

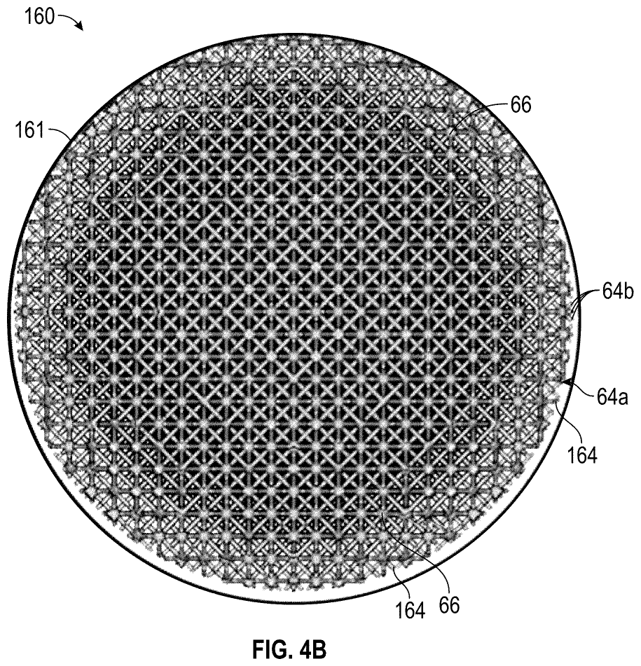

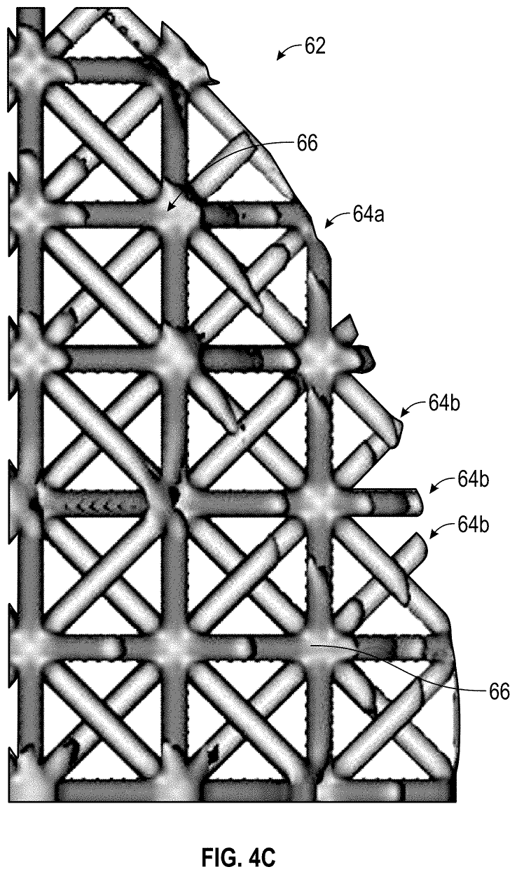

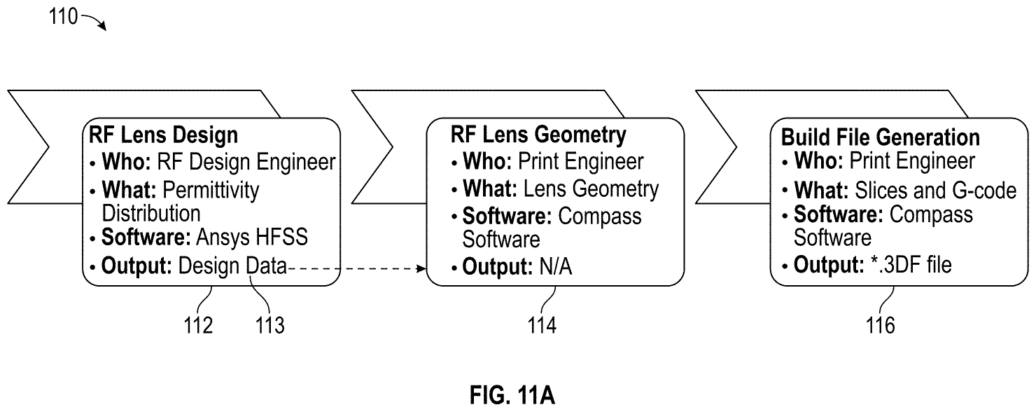

FIGS. 10A and 10B are close-up sections of surfaces 62, 162 of the spherical boundary of the lattice structure of FIG. 4A and FIG. 4B, respectively. FIG. 10C is a close-up section of surface 462 of lens 450. Unlike the Luneburg lens 350 that has empty spaces 162s at the surface 162 of the lens 350, Luneburg lens 450, which is molded of walled gyroid TPMS structures, has a surface 462 that closely matches a spherical boundary (e.g., the equivalent of spherical boundaries 61, 161 of FIGS. 4A and 4B, respectively). That is, the TPMS structure of surface 462 closely matches the spherical boundary (not shown) without generating weak struts or compromising the antenna aperture. As a result, the device 450 is more robust and has significantly better performance that Luneburg lenses 250 and 350.

Systems and Techniques for Generating a Build File to Manufacture RF Devices

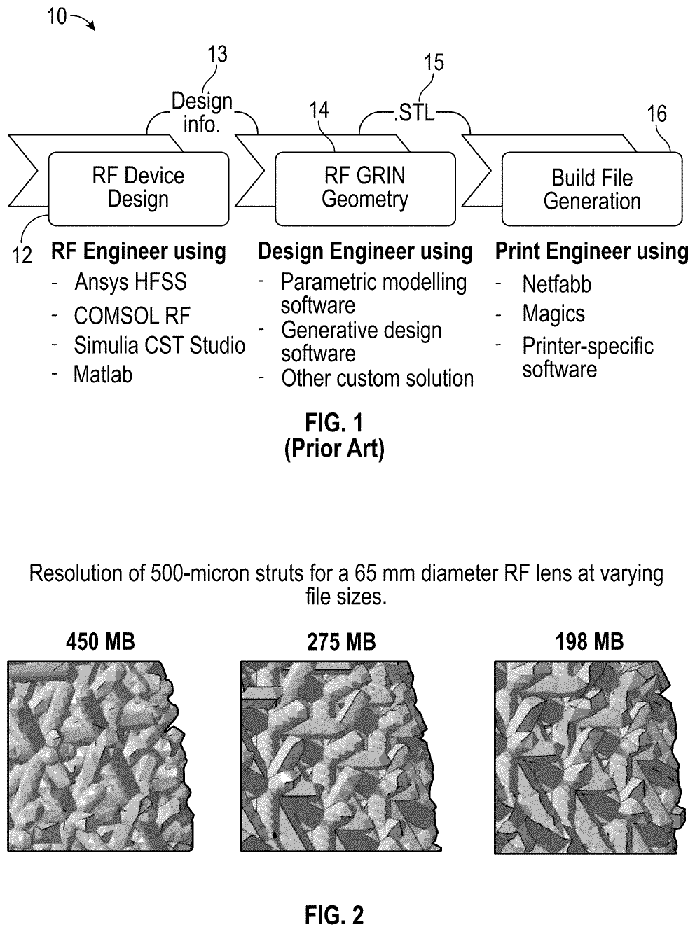

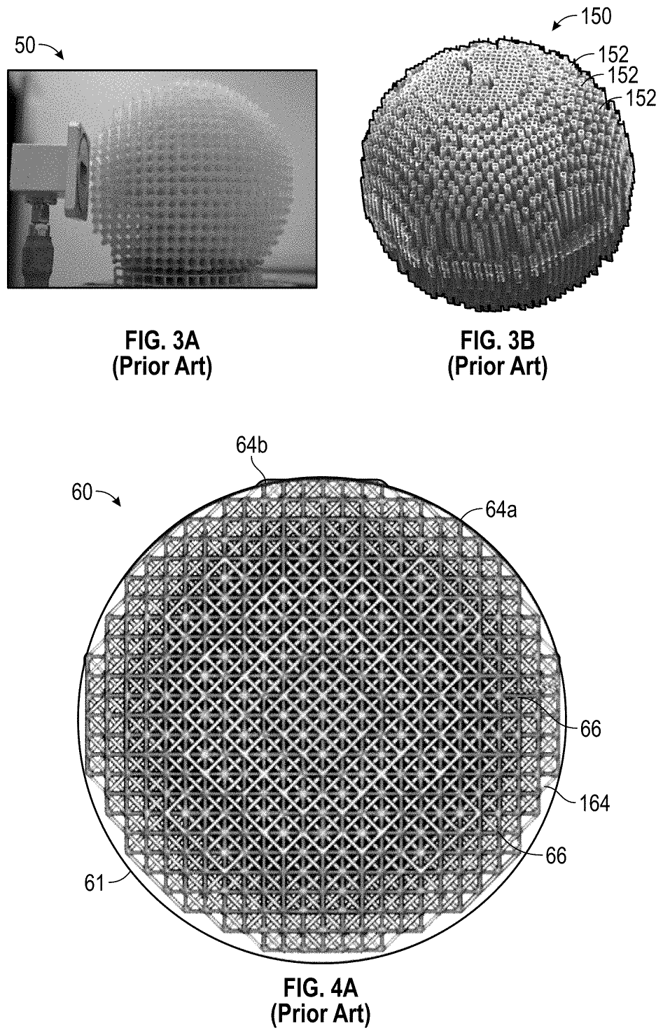

FIG. 11A illustrates a diagram of a workflow 110 of one exemplary embodiment for designing and generating a build file for use in 3D printing an RF lens (e.g., GRIN device). It can be contrasted to FIG. 1, with the illustrated middle action or step 114 of FIG. 11A being substantially different than the illustrated middle action or step 14 of FIG. 1, at least because step 114 bypasses the need for generating a CAD file to be communicated to the printer or other location where the build file is generated, such as at action or step 16, 116.

The design process for the workflow 110 can be akin to the initial design process of workflow 10. That is, different inputs, parameters, and the like, non-limiting examples of which are provided above with respect to step 12 and/or are known to those skilled in the art, can be inputted, determined, or otherwise provided as part of an RF lens design step 112. In the illustrated embodiment, inputted information includes permittivity distribution information, although other information can be provided in lieu of or in addition to permittivity distribution information. Similar to step 12, an RF engineer can determine or otherwise obtain this information, or program/provide programs to obtain this information, and/or the information can be determined or otherwise obtained from another source, such as a third party or some automated process. In at least some embodiments, the inputs can include a plurality of RF inputs, including but not limited to: (1) inputs derived from one or more simulations to determine preferred RF parameters for a to-be-printed RF device (e.g., inputs provided as point cloud data); (2) inputs derived from one or more equations (e.g., Luneburg Lens equation); or (3) inputs derived for use in designing a lens having assigned permittivity values across a plurality of concentric shells. The inputs can be provided, for example, by a customer, and/or can be generated using known data, computer models, artificial-intelligence software, and/or combinations of the same. The same types of software identified above with respect to step 12 can be used in conjunction with the design step 112, with the illustrated embodiment noting that Ansys HFSS software can be used. The utilized software can output design information or data 113 for use in eventually generating the build file. While in FIG. 1 the design data 13 was communicated to software used in the middle step 14, in FIG. 11 the design data 113 does not have to be communicated to the software used in the middle step 114. Instead the design data 113 can be communicated to the software being used to generate the build file. Technically, in the illustrated embodiment, that software (identified as Compass software) is the same software used in the middle step 114, but unlike FIG. 1, the design data 113 is not used in the middle step 114, and the software used in step 114 does not have to be the same software used in step 116.

Geometric design data can be inputted, determined, or otherwise provided as part of the RF lens geometry action or step 114. As shown, this action can be performed by a print engineer, which is in contrast to the middle step 14 of FIG. 1, in which the action is performed by a design engineer. Lens geometry can be selected, such as deciding one or more of: (1) the shape of the lens, for example selecting a desired boundary shape and/or size for the lens; (2) the configuration of the unit cell to create the lens, for example selecting a type, shape, and/or size of the unit cell; (3) the selection of one or more materials to be used in printing the lens; and/or (4) the selection of a frequency of operation of the lens to be printed, all of which are described herein and/or otherwise understood by a person skilled in the art in view of the present disclosures. Similar to other steps provided for herein, the input of the selections can be by a user (e.g., a print engineer), and/or the information can be determined or otherwise obtained from another source, such as a third party or some automated process (e.g., a process that determines a preferred selection for any of the RF lens parameters inputted at this stage, such as shape of lens and configuration of unit cell, among others). According to at least some embodiments, the software platform receiving this information and/or generating this information is “Fortify Compass,” which is available through 3DFortify Inc. of Boston, Mass., although a person skilled in the art will appreciate many different software platforms on which the present flowcharts and related disclosures can be implemented. As noted, in contrast to step 14, the step 114 does not provide any output that is relied upon for purposes of generating a build file. There is no three-dimensional polygon mesh (e.g., including vertices, edges, faces) and/or boundary representation model, such as a CAD file or the like created (e.g., .STL, .STEP, .3MF, .AMF, and .IGES files), and there is no lattice graphically rendered based, for example, on dielectric constant values in three-dimensional space.

The build file generation action or step 116 occurs by factoring in the design data outputted from the RF lens design step 112, as well as the information provided in the RF lens geometry step 114 (referred to as “lens geometry” information in at least some instances), the latter of which is merely provided as the inputted information rather than any separately created file (e.g., CAD file or the like). A print engineer can perform this function using various software tools known to those skilled in the art, including but not limited to the aforementioned Fortify Compass software platform. Actions associated with processing the build file include, but are not limited to, generating slice images and/or generating instructions for driving an AM device (referred to in FIG. 11A as G-code), among other features. These actions can be performed on a software platform like “Fortify Compass” or other platforms. As discussed herein, a variety of types of 3D printing (e.g., SLA, DLP, LCD, among others) and 3D printers can be utilized (e.g., top-down DLP printer, bottom-up DLP printer, and other DLP and non-DLP printers as well), and the build file can be built and processed in a manner suitable for the type of 3D printing being performed and/or the printer being used. Additional details about ways by which slices can be formed and image generated for printing are disclosed in U.S. patent application Ser. No. 17/717,019, entitled “Digital Image Transformation to Reduce Effects of Scatter During Digital Light Processing-Style Manufacturing,” filed Apr. 8, 2022, the content of which is incorporated by reference herein in its entirety. Ultimately, a build file is generated, based at least in part on the design data 112 and lens geometry information from step 114. As identified in step 116, the build file can be a .3DF file, although other file formats are possible. The use of the .3DF file, or other similar file, is superior to the use of a CAD file because the .3DF file contains the design of the pens paired with information needed to run the printer. There is no need to represent the geometry prior to converting it into a build file, which is unlike a CAD file.

Referring to FIG. 11B, a flow diagram of a workflow 510 that provides more particular details about one exemplary embodiment for designing and generating a build file for use in 3D printing an RF lens (e.g., GRIN device) is illustrated. The workflow 510 is utilized to get from an RF device design step, such as the step 112 of FIG. 11A, to a printed part, formed from a build file, such as occurs at the step 116 of FIG. 11A.

Action: Receiving RF Design Data

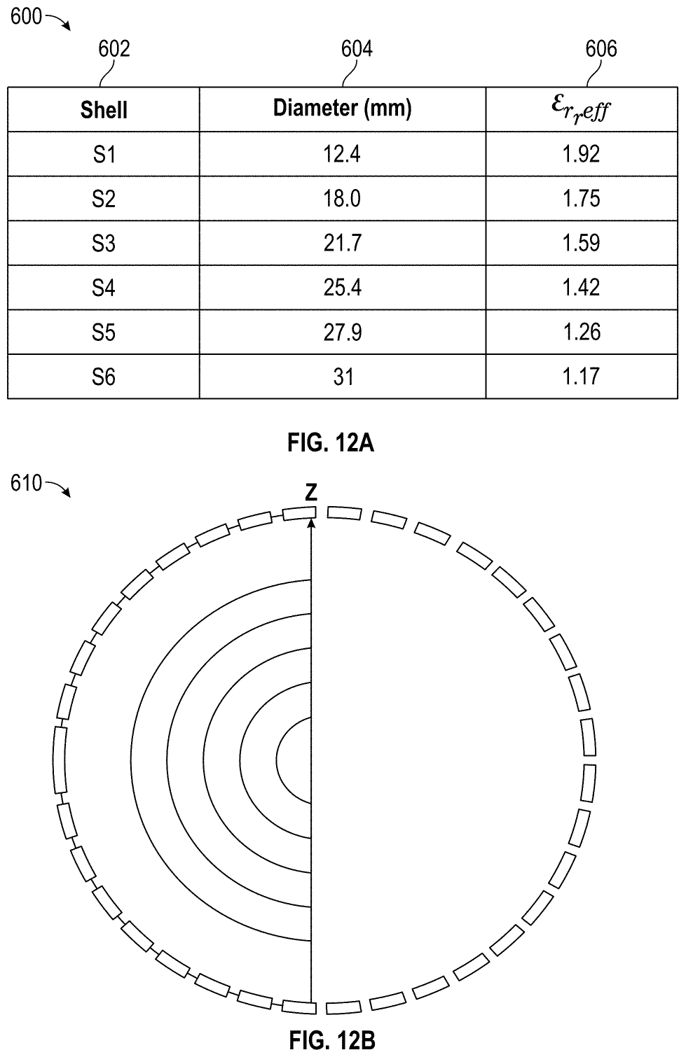

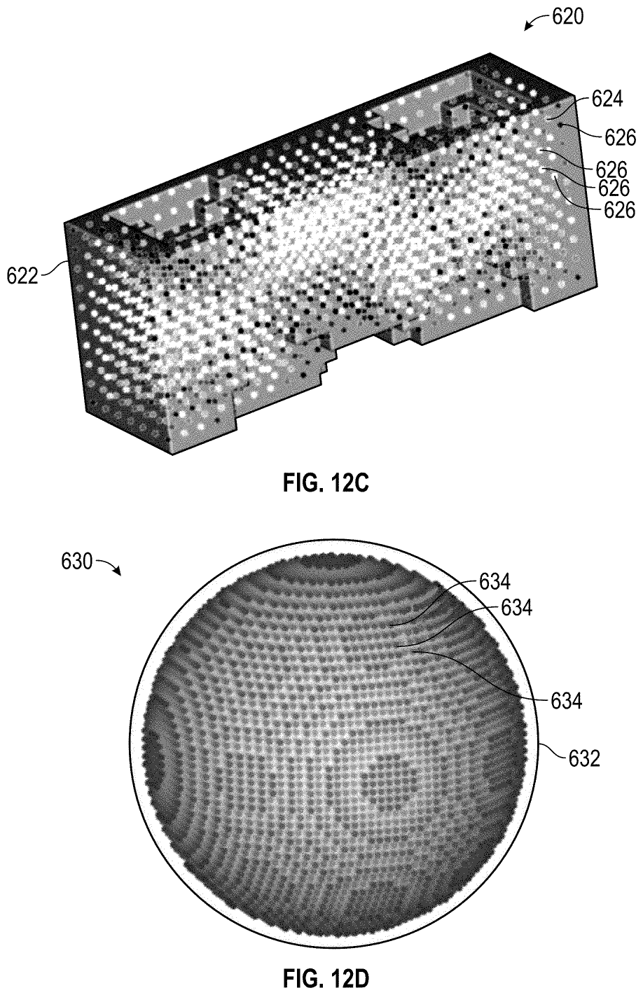

Similar to the workflow 110, the workflow 510 receives, derives, or otherwise obtains RF design data at action or step 512. As discussed above, the data can be received in various types. For example, data can be received in which a user performs RF simulation work in software such as HFSS or CST Studio Suite®. RF data can have various types. For example, to produce a spherical lens boundary, the data can be in a shell format. That is, the design data is received as a series of shells, as shown concentric shells, with an assigned permittivity per shell. FIG. 12A shows table 600 with one example of RF data that can be used to produce a spherical shell boundary. As shown, table 600 includes column 602, which identifies the various shells (e.g., S1, S2, S3, S4, S5, S6), and then columns 604 and 606, which provide diameter and effective permittivity values for each shell, respectively. In this example, six shells are provided, but a person skilled in the art will appreciate fewer or more shells can be used. Likewise, other types of inputs that are not necessarily tied to shells can be used. Different shapes and configurations are possible that are not necessarily spherical. For example, the point cloud approach described herein, as well as instance of more explicitly defining a geometry by way of an equation/curve, such as the Luneburg lens equation, also provided for herein. FIG. 12B shows a schematic side view of a part of a spherical shell boundary 610 created from RF data of FIG. 12A. The different color shading represents different effective permittivity values.

Alternatively, or additionally, RF design data provided in conjunction with step 512 can be in a form of one or more equations. For example, a user planning to create a Luneburg lens with a specific radius can utilize the following Luneburg lens equation:

εᵣ(r)=2−(r/R)² Eq. (3)

where r is a radial distance from lens center and R is an outer radius of the lens. The software utilized (e.g., Fortify Compass software) can interpret this equation and directly generate the geometry without needing to explicitly define shells or points in space.

Still further alternatively, or further additionally, RF design data provided in conjunction with step 512 can be received as point cloud data, or in a point cloud data format, for example in a CAD file, such as an .STL file. Such files may be provided by a customer, for example. The size of such a file in this instance is more manageable as described elsewhere herein because the file typically includes much less information and is only being downloaded for obtaining this information. The CAD file itself is not necessarily communicated for use in the file build step (e.g., the step 116 and/or the build layout step 522). For example, the design data can be received in step 512 as a point cloud and a boundary. In this situation, e.g., the lens boundary need not be spherical. FIG. 12C shows a perspective view of one exemplary embodiment of data or file 620 received regarding a desired lens structure. The boundaries can be seen based on the general shape of an illustrated structure 622 (as shown, a substantially rectangular prism, though with some modifications to the same), and then relevant information for the print job can be provided as point cloud data positioned with respect to the structure 622. In the illustrated embodiment, desired effective permittivity values are illustrated as data points 624 that together form a point cloud 626, the data points 624 being distributed within a volume of the illustrated structure 622. In at least some embodiments, this data can be color-coded such that the spectrum of colors can be used across the point cloud 626 to illustrate desired effective permittivity values. For example, colors on or nearer a red end of the light spectrum can represent higher permittivity values and colors on or nearer a blue end of the light spectrum can represent lower permittivity values, including non-existent values because that portion of the print is air. Other parameters, in addition to or in lieu of effective permittivity values, can be illustrated as well. FIG. 12D is a side view of another exemplary embodiment of data or file 630 received regarding a desired lens shape. As shown, the data includes an .STL file design of a structure 632, as shown a sphere, and also point cloud data 634. Details about the structure 632 and data 634 is similar to the details provided with respect to the structure 622 and the data 624.

Actions to receive, derive, or otherwise obtain RF data can include performing RF simulation work in software such as HFSS or CST Studio Suite® until an optimized simulated antenna performance is achieved. The resulting model and simulation can be performed with bulk materials of a fixed dielectric constant that represents what will become an effective dielectric constant of a lattice. After simulation, the 3D model of the part can be exported, including dimensions for each section of the antenna and the corresponding effective dielectric constant for each section as the bounding box of the part. Parameters that can be used to form the eventual build file can include a lattice of uniform density using, by way of non-limiting examples, one or more of: volume fraction control, strut thickness control, permittivity control; and/or unit cell control.

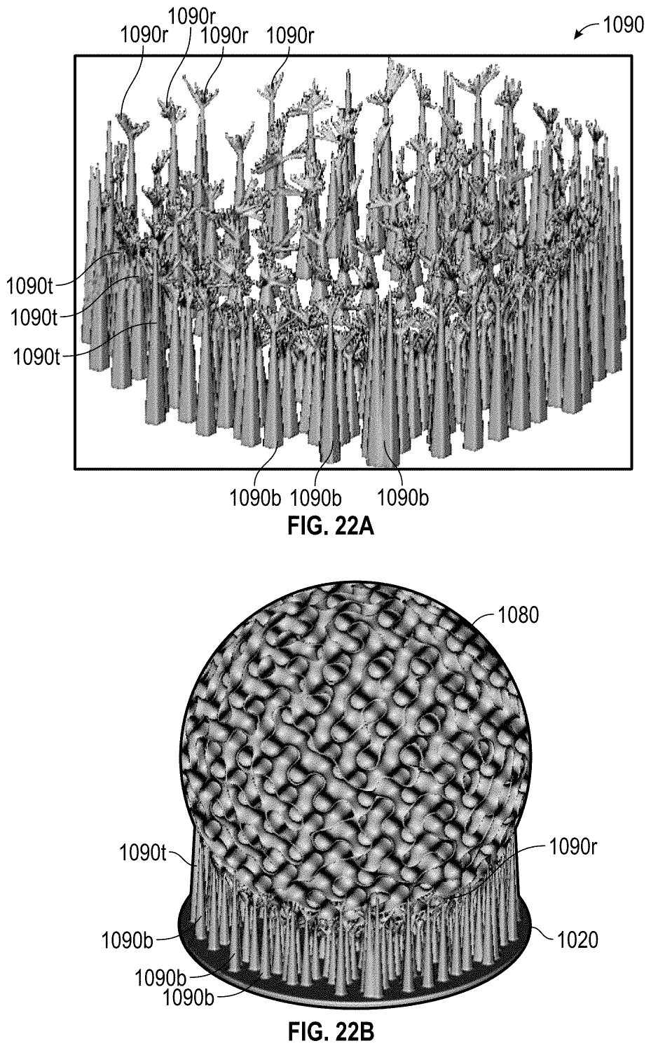

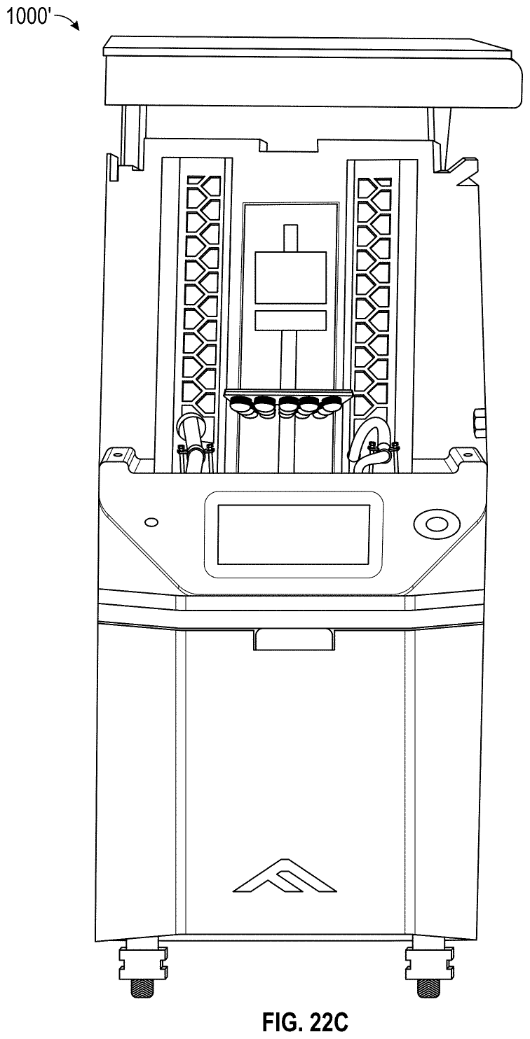

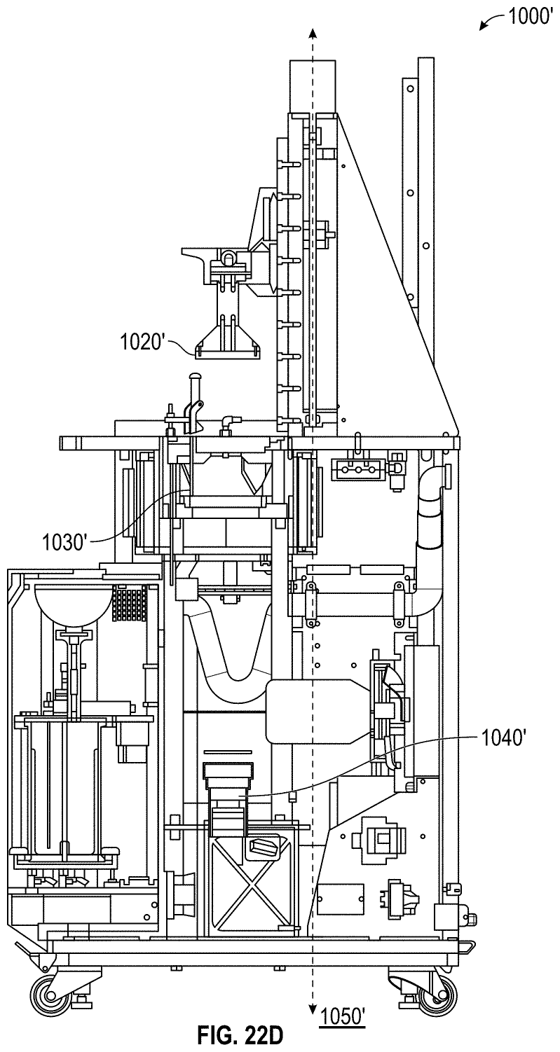

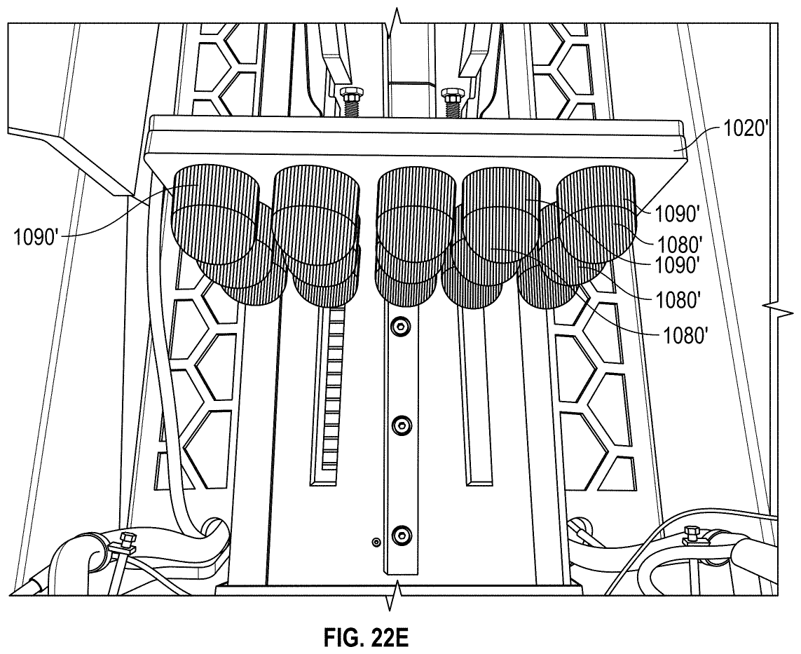

More generally, as provided for herein, or otherwise understood by a person skilled in the art in view of the present disclosures, design inputs for an RF device to be printed can include one or more of any of the following, in any combination when more than one: a desired design type for the RF device (e.g., a Luneburg lens, a Luneburg-style lens, Gutman lens, among others), a weight of the RF device, a shape of the RF device, a size of the RF device, an aperture size(s) associated with the RF device, a gain for the RF device, a frequency of operation for the RF device, and/or a focal distance from a surface to a center of the RF device. In some exemplary embodiments, a method of designing or manufacturing an RF device can include receiving one or more of these design inputs and then suggesting a design output for the RF device to be printed. The action of suggesting can be based on the disclosures provided for herein. Some non-limiting examples of such outputs, as provided for herein or otherwise known to those skilled in the art, include a dielectric constant distribution, at least one of a lattice structure selection or a TPMS structure selection, one or more support structures (support structures are described in greater detail below at least with respect to FIGS. 22A and 22B), a device size, and/or a device boundary, among others. In at least some instances, the receiving and suggesting steps provided for in this paragraph can be performed without obtaining RF inputs and/or without generating a mesh (e.g., a CAD file, such as an .STL file, a .STEP file, a .3MF file, an .AMF file, and/or an .IGES file, among others).

Action: Convert RF Data to Volume Fraction of Air and/or Wall or Strut Thickness

After receiving the RF type data at step 512, the data, which more generally can include information about structure 622, 632 and data 624, 634 in the illustrated examples, can be converted to another format of data in conjunction with action or step 514. For example, in the illustrated embodiment, at this step 514 the RF type data can be converted to volume fraction of air. The volume fraction of air represents a ratio of air volume to total volume of the lens to be printed, and an equation related to the same (Equation 5) is provided further below.

Unlike step 14 of FIG. 1, which uses CAD packages to represent RF design as an .STL or .STEP file that creates large file data as outputs (including complex lattice structures), step 514 converts data to volume fraction of air and uses that as a data to generate the desired geometry for use in creating a build file. As stated above in connection to FIG. 1, the structures printed by workflow 10, which is the method currently used in industry, are less likely to survive the printing process. This is due, at least in part, to a high likelihood of cracking or breaking off the device when the device is handled or agitated because of the undesired surface boundaries explained at least in connection to FIGS. 4A-4C and 10A-10C. Also, the requirement of complex simulation and design techniques that require high amounts of compute power and/or a complicated workflow create further complications. In contrast, workflow 510 converts the received RF data to volume fraction of air, i.e., converting RF data to another form of data to give density value for each point in a desired space, a much easier data set to handle that provides as good, if not better, resulting print jobs. This is explained in more detail below.

Regardless of how dielectric constant data, such as effective permittivity values, is received at step 512, the present process provides for ways by which the data can be converted into a volume fraction of air. In general the dielectric constant (Dk) field is specified as a set of values at positions in space. That is, the Dk field can be described as a list of 4-tuples: [x, y, z, Dk]. Given that field, the workflow 510 can be designed such that the desired Dk is approximately at a center of each of the unit cells. In at least some embodiments, RF inputs can include a plurality of dielectric constant values in three-dimensional space.

There are several interpolation techniques that can be used for determining Dk field locations with respect to a device to be printed, and more particularly a unit cell of such a device. A person skilled in the art, in view of the present disclosures, will understand how to utilize such interpolation techniques in conjunction with the present disclosures. By way of non-limiting example, trilinear interpolation or k-nearest neighbor are two suitable interpolation techniques. In one interpolation technique involving nearest neighbor determination, determining a geometric-defining property value(s) across a volume of a planned RF device to be printed can include identifying a nearest data value to each unit cell and assigning the one or more geometric-defining property values for each unit cell, or part thereof, of the planned RF device to be printed. The assigning can be based, for instance, on the identified nearest data value. Additional information about how to implement suitable interpolation techniques can be found in open source tool scipy, for example at:

https://docs.scipy.org/doc/scipy/reference/generated/scipy.interpolate.RegularGridInterpolator.html;
https://docs.scipy.org/doc/scipy/reference/generated/scipy.interpolate.NearestNDInterpolator.html; and
https://docs.scipy.org/doc/scipy/reference/generated/scipy.interpolate.LinearNDInterpolator.html #scipy.interpolate.LinearNDInterpolator.

Once the Dk value for a given unit cell is known, the volume of material needed to achieve this Dk value can be calculated, for example, based on it being a linear relationship. Once the volume is known, the dimensions of the geometry can be determined. These dimensions can depend, at least in part, on the type of unit cell being used to build the object being printed, e.g., a Luneburg lens. For example, a face-centered cubic unit cell (FIG. 7J) can be composed of twelve (12) half cylinders and the total volume can be calculated by the following equation:

V=6πr²h Eq. (4)

where h is the length of the diagonal of a unit cell. The strut radius, r, can be calculated in view of the same. A person skilled in the art, in view of the present disclosures, will understand how to determine other equations to be used with the other unit cells and TPMSs provided for herein to properly interpolate air fraction values across volumes of objects being printed using these other unit cells and TPMSs. In view of these interpolation techniques, the workflow 510 at step 514 can process this unstructured Dk field to solve for the density and/or strut thickness of each unit cell, allowing for smooth transitions of these values from unit cell to unit cell.

Non-limiting examples of unit cells that include smooth translations are provided for in FIGS. 13A-13D. More particularly, FIGS. 13A-13B illustrate a unit cell 70b′ having a walled gyroid design, similar to the design of the unit cell 70b in FIG. 7B. As shown, a thickness of walls 71b′ can be adjusted in any of the x, y, and z dimensions, also referred to as x, y, and z planes herein. In the illustrated embodiment, a thicker portion of the one or more walls 71b′ is represented by a wall thickness of 71b₁′ and a thinner portion of the same wall(s) 71b′ is represented by a wall thickness of 71b₂′. More particularly as shown, a gradient of thicknesses can be achieved along a length of the wall(s) 71b′, with the thickness changing across a portion, up to an entire, length of the wall(s) 71b′. Similarly, FIGS. 13C-13D illustrate a unit cell 70h′ having an Octet design, similar to the design of the unit cell 70h of FIG. 7H. As shown, a thickness of struts 71h′ can be adjusted in any of the x, y, and z dimensions. In the illustrated embodiment, a thicker portion of the one or more struts 71h′ is represented by a wall thickness of 71h₁′ and a thinner portion of the same strut(s) 71h′ is represented by a wall thickness 71h₂′. More particularly as shown, similar to FIGS. 13A-13B, a gradient of thicknesses can be achieved along a length of the strut(s) 71h′, with the thickness changing across a portion, up to an entire, length of the strut(s) 71h′.

In addition to adjusting a thickness of walls or struts across any of the x, y, and z dimensions in a single unit cell, the thickness of walls or struts can be adjusted across a plurality of aligned unit cells across any of the x, y, and z dimensions as well. Accordingly, by combining unit cells to form a planned RF device, a gradient of thicknesses can be formed across a volume of the planned RF device to be printed. This ability extends to other properties as well. That is, the present disclosure provides for a gradient of other geometric-defining property values to be achieved as well, both across a unit cell and across the object to be printed.

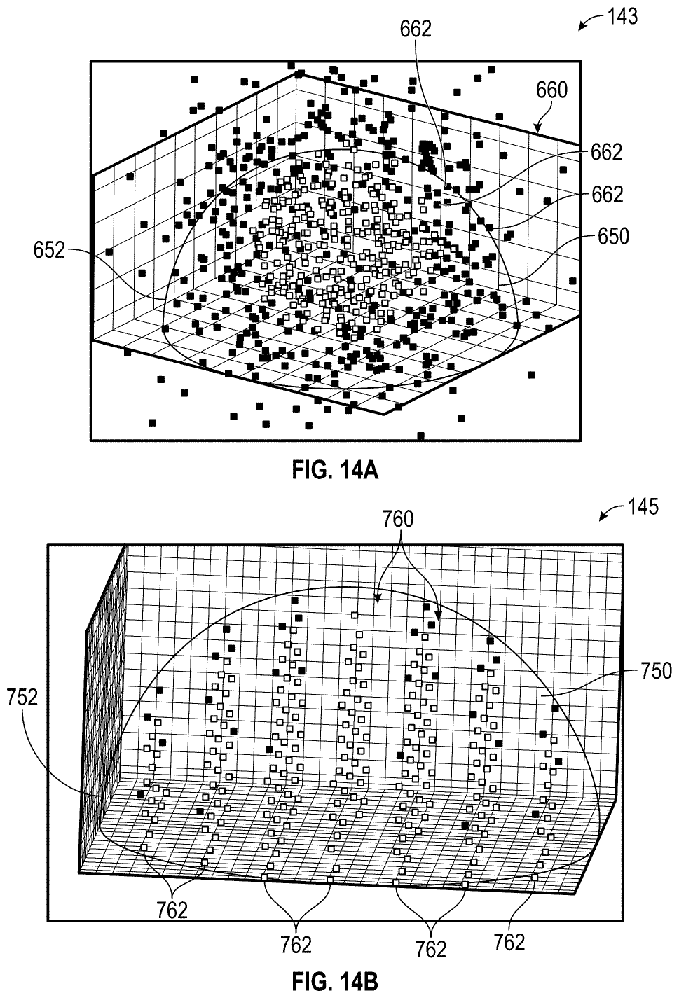

As noted above, several interpolation techniques can be used to determine Dk field locations with respect to a device to be printed. Further examples of such techniques are provided for in FIGS. 14A-14B. The graphs provided for in FIGS. 14A-14B can be generated using a software product like Fortify Compass, the graphs providing a volumetric representation of voxels of various colors and/or shades, which in turn can represent a value of the dielectric constant. The graphs can be, for example, in a .CSV file format.

FIG. 14A is a simulation graph 143 of a density field 660 of a spherical Luneburg lens 650 to be printed. The data can be generated using techniques known to those skilled in the art. For purposes of the present discussion, it can be understood that in some instances a customer may supply this data to a user operating the software that will generate the build file from this data, and from geometric data (as described further below).

A desired boundary of the lens 650 is illustrated as a hemisphere 652, and a desired density, based at least in part of a desired Dk value at a particular location within a volume of the lens 650, is illustrated by an array of points 662 that form the density field 660. Because often the desired density value is symmetrical within a Luneburg lens such that a desired value is approximately the same within an equivalent, symmetrical location within each respective quadrant of the lens, a quarter of a sphere or a hemisphere can be effective to illustrate a location of the points 662 with respect to a volume of the lens 650, although a similar graph can be provided for an entirety of the lens 650, i.e., a full sphere image having a density field presented with respect to the same. While in the illustrated embodiment the points 662 are provided in a shaded grayscale, in practice the points 662 can be color-coded across a spectrum of colors. For example, colors at a red end of a spectrum can represent a highest density in the lens and colors at a green and blue spectrum can represent a lowest density in the lens, or even densities that are zero, i.e., they are not in the lens. In the illustrated embodiment, points 664 outside of the lens in FIG. 14A represent zero densities that are not part of the lens.

The points 662, 664 that are included in the figure are considered to be a random or arbitrary grid configuration. This means that the illustrated data is selected arbitrarily, and not necessarily in view of any geometry that is being targeted for printing. Accordingly, as shown, there are many points 664 that fall outside of the hemisphere 652. The data is all data that is sampled above the x-y plane. The data can be provided in a 4-tuple format as described above: [x, y, z, Dk]

FIG. 14B is a simulation graph 145 of a density field 760 of a spherical Luneburg lens 750 to be printed, the lens 750 being illustrated as a hemisphere 752. The field 760, and thus the array of points 762 thereof, can be similar to those illustrated in FIG. 14A except in this instance the density field 760 is illustrated as a regular grid configuration, and further, points that fall outside of the desired boundary of the lens 750 are removed from the graph 145. A regular grid configuration, sometimes referred to as a uniform grid configuration, means that the points 762 illustrated are not arbitrarily selected like the points 662, 664 in FIG. 14A, but rather, they are specifically chosen, such as at regular intervals of the illustration (e.g., points at certain intervals along the x, y, and/or z axes). Thus, when the data is provided in a 4-tuple format (e.g., [x, y, z, Dk]), at least one of the x, y, and z values may be held constant for multiple points to create the regular grid configuration. Similar to FIG. 14A, the data is all data that is sampled above the x-y plane. The data from FIGS. 14A and 14B can be exported to the software that will create the build file, for instance in the aforementioned 4-tuple format. Either format—arbitrary grid configuration or regular grid configuration—can be used in conjunction with the present disclosures.

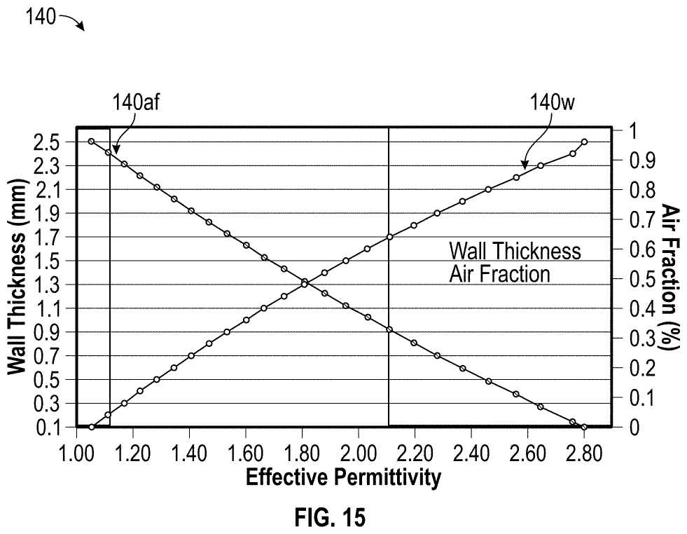

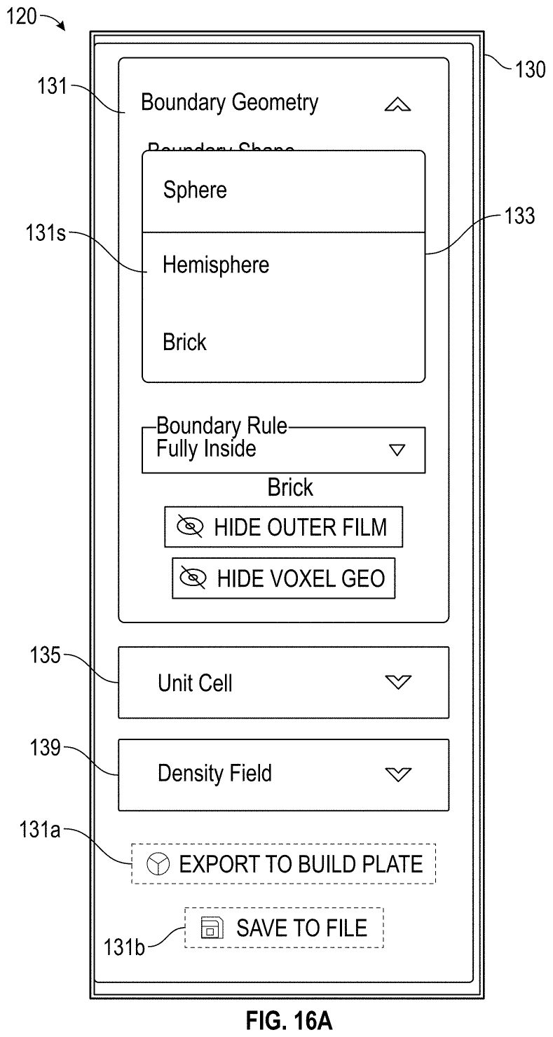

Related to the interpolation performed to make determinations about Dk values across a volume of the lens to be printed, is factoring in macroscopic properties of composite materials used to print the desired lens, referred to by those skilled in the art interchangeably as Effective Medium Approximations (EMA) or Effective Medium Theory (EMT). There are a variety of formulas that can be used to approximate the macroscopic properties of a composite material. In all approximations, the approximations assume that the macroscopic system is homogenous. Some such approximations are the Maxwell Garnett equation, Bruggeman's model, and the Clausius-Mossotti relation. Each approximation cam work under a specific set of criteria such as concentration of inclusions, shapes of inclusions, volume fraction thresholds, etc. In one embodiment, by using Eq. (5), the RF data can be converted to volume fraction of air.

$${ε}_{r , eff} = {ε}_{r , r e s i n} \frac{1 + 2 {v}_{a i r} ( \frac{1 - {ε}_{r , resin}}{1 + 2 {ε}_{r , resin}} )}{1 - {ν}_{a i r} ( \frac{1 - {ε}_{r , resin}}{1 + 2 {ε}_{r , resin}} )} \qquad Eq . ( 5 )$$

where ε_{r,eff} is the effective permittivity, vₐᵢᵣ is the volume fraction of air, and ε_{r,resin} is the permittivity of the solid. Therefore, for a given volume fraction of air, the resultant effective permittivity can be calculated. FIG. 15 shows the relationship between air fraction and wall thickness to permittivity in graph 140. As shown, as wall thickness, illustrated as line 140w increases, so too does the effective permittivity, while as air fraction decreases, illustrated as line 140af, effective permittivity increases. This graph helps illustrate what value a wall thickness can be and/or what value an air fraction can be to achieve a desired effective permittivity, as the three parameters can be inter-related. The values of wall thickness and air fraction are approximately inversely proportional, and thus generally either one of these two parameters can be targeted to achieve the desired effective permittivity. Other factors will also impact how the effective permittivity relates to wall thickness and air fraction, including but not limited to the geometry and size of the unit cell and the type of material being used to produce the part, among others, and which is addressed further below.

Action: Converting Volume Fraction of Air to Wall or Strut Thickness in View of Geometry Data—Entering Geometry and RF Data

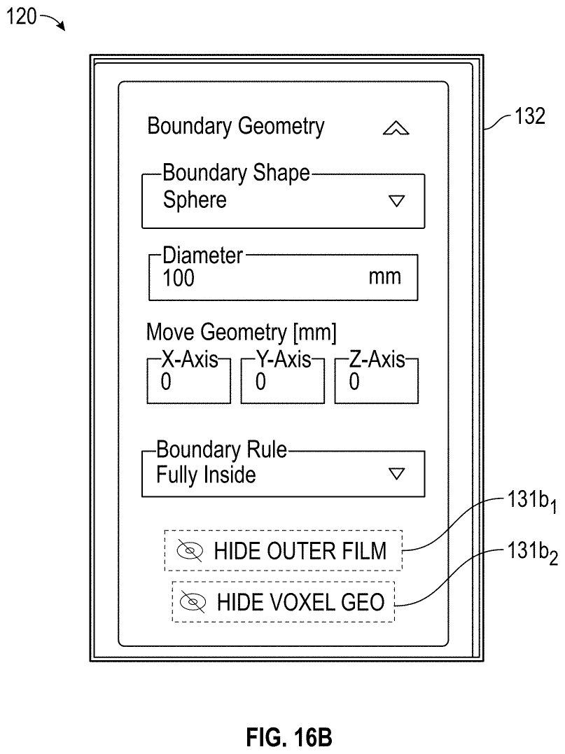

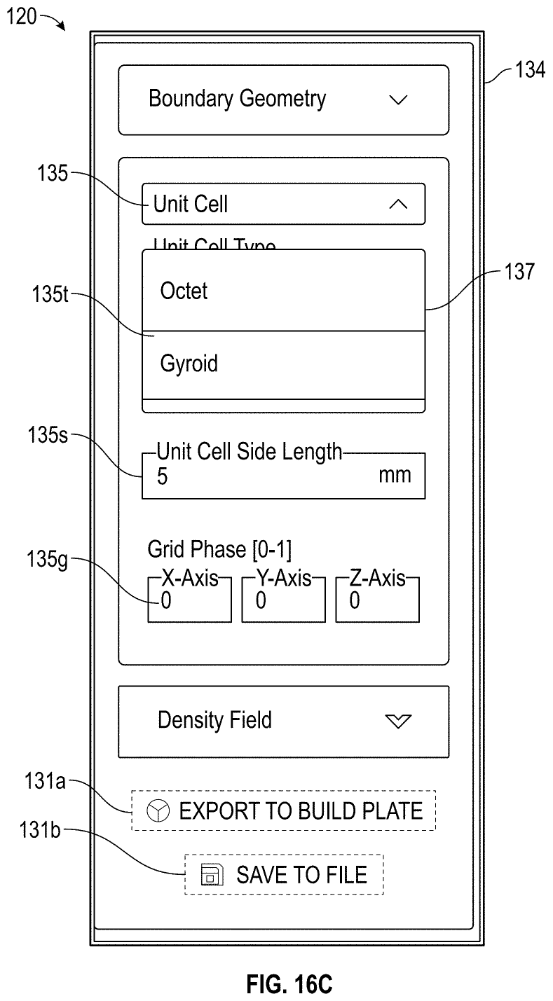

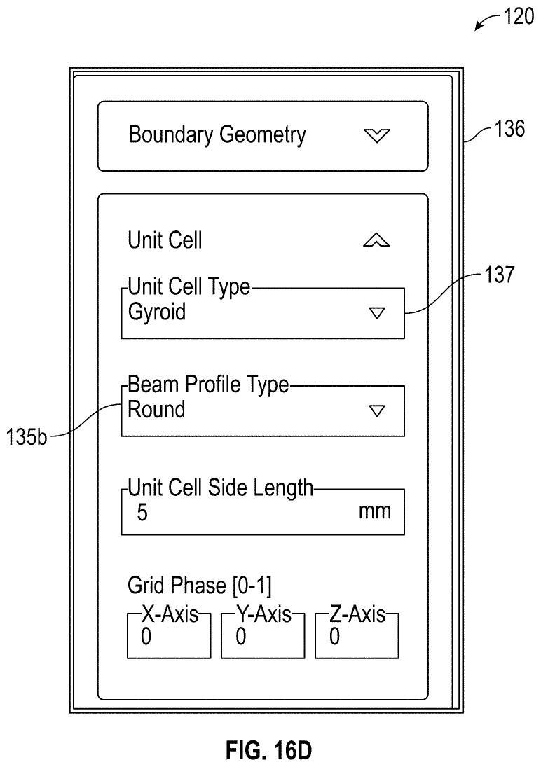

As illustrated in FIG. 11B, after RF data is converted to volume fraction of air, an action or step 516 of the workflow 510 involves converting the volume fraction of air to wall or strut thickness. In this step, a user can define a frequency of operation. Additionally, or alternatively, a user can select the desired unit cell type (e.g., TPMS, octet, etc.) and/or geometries (e.g., boundaries, shapes, sizes, etc.) in conjunction with the step 516, as described below with respect to FIGS. 16A-16D. Like the other embodiments provided for herein, while input is described as a user defining or otherwise inputting certain information, in some embodiments the input can be received from an outside source (e.g., third party) or can be determined, measured, etc. through some automated process or the like. Step 516 can be the equivalent of step 114 in the workflow 110 of FIG. 11A.

FIGS. 16A-16D illustrate screenshots of one non-limiting embodiment of a user interface (UI) 120 that can be provided to allow a user to input information and/or parameters to help define the eventual build file that will be created to enable building an object by way of AM, such as a GRIN device. The UI 120 can include a plurality of modules or sections. In the illustrated embodiment, three modules or sections are provided: boundary geometry 131, unit cell 135, and density field 139. Each module or section of the UI 120 can also be considered non-limiting such that various modules or sections can be mixed and matched as appropriate or desired. Further the information and/or options contained within those modules (e.g., boundary shape and boundary rule for the boundary geometry module 131) can likewise be mixed and matched as appropriate or desired.

FIG. 16A, for example, provides for a screenshot 130 of the user interface 120 for inputting information about an object to be printed. The screenshot 130 illustrates each of the three modules: a boundary geometry module 131, a unit cell module 135, and a density field module 139 for the object to be printed. As shown, the boundary geometry module 131 includes a selection input 131s for boundary shape, as shown a drop-down menu 133, and a selection input 131r for boundary rule, which can also be a drop-down menu, although the menu itself is not displayed in FIG. 16A.

Starting first with the selection input 131s for boundary shape, when selected, the drop-down menu 133 can display. In the illustrated embodiment, the drop-down menu 133 includes three shape options: sphere, hemisphere, and brick, although a person skilled in the art will appreciate many other options that can be provided without departing from the spirit of the present disclosure, including but not limited to cylinder and dome. In some embodiments, upwards of 20, or even more, boundary geometries can be provided.

FIG. 16B shows a screenshot 132 of the UI 120 of FIG. 16A after sphere has been selected as part of the boundary geometry module 131. Depending on the selection made from the drop-down menu 133, the parameters that get pulled up in the boundary geometry module 131 can change. Accordingly, while in FIG. 16B the screenshot 132 provides for a diameter length and move geometry in millimeters for each of an X-axis, Y-axis, and Z-axis, other options can be associated with a sphere selection and/or a different selection (e.g., brick) can pull up different information for a boundary geometry (e.g., a length instead of a diameter). The move geometry can relate to an amount a user wants to move the boundary, such as the boundary illustrated by the hemispheres 652 and 752 in FIGS. 14A and 14B, respectively. This may be desirable, for example, if the RF data provided is on a different scale and/or has a different starting position than the geometry data that is entered. This can happen, for example, if the inputted data has two different origins. Allowing for the geometry to be moved permits a user to ensure the geometry boundary and the data field can be aligned. By way of non-limiting example, if a boundary geometry is a cube in which the origin is located at the corner of the cube, but the data field origin is located in the center of the cube of data, then an adjustment of the boundary geometry is necessary to align the geometry boundary and the data field. The boundary can be moved in both directions along each of the three X, Y, and Z axes.

Turning next to the selection input 131r for boundary rule, when selected, a drop-down menu (not shown) can be displayed and can operate in a similar manner as the drop-down menu 133 associated with the selection input 131s for boundary shape. In the illustrated embodiment, the selected input 131r for the boundary rule is “fully inside,” but a person skilled in the art will appreciate other options that can be provided in a drop-down menu, such as “mostly inside” or “partially inside.” The boundary rule addresses how the user wants to treat a situation in which a unit cell does not fit fully within the boundary. At a high level, it allows a user to decide if a unit cell touches a boundary, should it be included as part of the object to be built or not. More specifically for a cubic unit cell, a “fully inside” designation can require all eight corners of the unit cell to be inside the geometry boundary to be kept, a “mostly inside” designation can require a majority (at least four) corners of the unit cell to be inside the geometry boundary to be kept, and a “partially inside” designation can require at least one corner of the unit cell to be inside the geometry boundary to be kept. A person skilled in the art will appreciate other designations that can be provided and other requirements that can be set (e.g., fewer or more corners), depending, at least in part, on the geometry of the boundary and/or the type of unit cell selected.

In the illustrated embodiment, the boundary geometry module 131 also includes two buttons: a hide outer film button 131b₁ and a hide voxel geo button 131b₂. The hide outer film button 131b₁, when selected, hides the boundary, such as the hemispheres 652 or 752 in FIGS. 14A and 14B, respectively. Further, the hide voxel geo button 131b₂, also referred to as the hide unit cell button, when selected, hides unit cells that can be displayed to illustrate how the print job will look as a fully printed part. In the illustrated embodiments of FIGS. 14A and 14B, the unit cells are hidden, otherwise it would be difficult to see the density fields 560, 660. If they were illustrated, they can be illustrated as cubes, regardless of the type of unit cell selected by the user, thus creating a blocky-look to the object to be printed. In other embodiments, the illustrated unit cells can be reflective of the type of unit cell selected by the user. Unit cell selection is discussed with respect to FIG. 16C and the unit cell module 135. For both button 131b₁ and button 131b₂, the selection to “hide” is merely a visual change to assist a user when trying to view certain portions of the file; it does not impact the resulting print.

FIG. 16C shows a screenshot 134 of the UI 120 of FIG. 13A in which the unit cell module 135 is being utilized. As shown, the unit cell module 135 includes a selection input 135t for unit cell type, as shown a drop-down menu 137, a selection input 135s for unit cell side length, which as shown is a field where a number can be input, as shown an amount in millimeters, and a selection input 135g for grid phase for each of an X-axis, Y-axis, and Z-axis. The grid phase can define where the unit cell falls in relation to the bounding geometry. Thus, the selection input 135g can help a designer visualize how a unit cell populates a boundary and better understand the impact of the design selections at the boundary edges. In the illustrated embodiment the drop-down menu 137 provides two unit cell options—octet and gyroid—although a person skilled in the art will appreciate many other options that can be provided without departing form the spirit of the present disclosure, including but not limited to the unit cell options provided above with respect to FIGS. 7A-7J.

Similar to the selection input 131s for boundary shape, depending on the selection made from the drop-down menu 137 for the selection input 135t for unit cell type, the parameters that get pulled up in the unit cell module 133 can change. Accordingly, while in FIG. 16D a screenshot 136 of the UI 120 provides for a beam profile type based on “gyroid” being selected from the drop-down menu 137, other options can be associated with a “gyroid” selection and/or a different selection (e.g., octet) can pull up different information for a unit cell. As shown, selecting “gyroid” yields a selection input 135b for a beam profile type. It can be a drop-down menu (not shown), and in the illustrated embodiment the selected input is round. A person skilled in the art will appreciate various drop-down menus and other ways by which data can be inputted (e.g., typed, uploaded, etc.) are also possible, and thus the illustrated embodiments are by no means limiting as to how selections can be made, options for selections that may exist, and/or information and/or parameters that can be used to help create a build file.

The density field module 139 provides for a way for a user to input or otherwise provide the information about the desired density field, such as the information from FIGS. 14A and 14B and/or other ways by which RF data can be provided (see, e.g., step 112 in FIG. 11A and related descriptions, step 512 in FIG. 11B and related descriptions, and FIGS. 12A-12D and related descriptions). In at least some embodiments, selecting this module may pull up a window to allow the user to select a file that includes the density field information. Alternatively, or additionally, the density field module 139 can provide a way by which a user can input equations, such as the RF input described above related to equations. Any of the RF input methodologies provided for herein or otherwise skilled in the art can allow for density field data to be inputted in the UI 120.

The “Export to Build Plate” button 131a exports the designed build file, which is based on the geometry data entered by way of the boundary geometry module 131 and the unit cell modules 135, as well as the RF data entered by way of the density filed module 139, to a portion of the software that includes an illustration of the build plate so the user can see how the build will be made with respect to the build plate. The “Save to File” button 131b provides for a way for the build file to be saved.

Action: Converting Volume Fraction of Air to Wall or Strut Thickness in View of Geometry Data—Correlating the Data to the Design

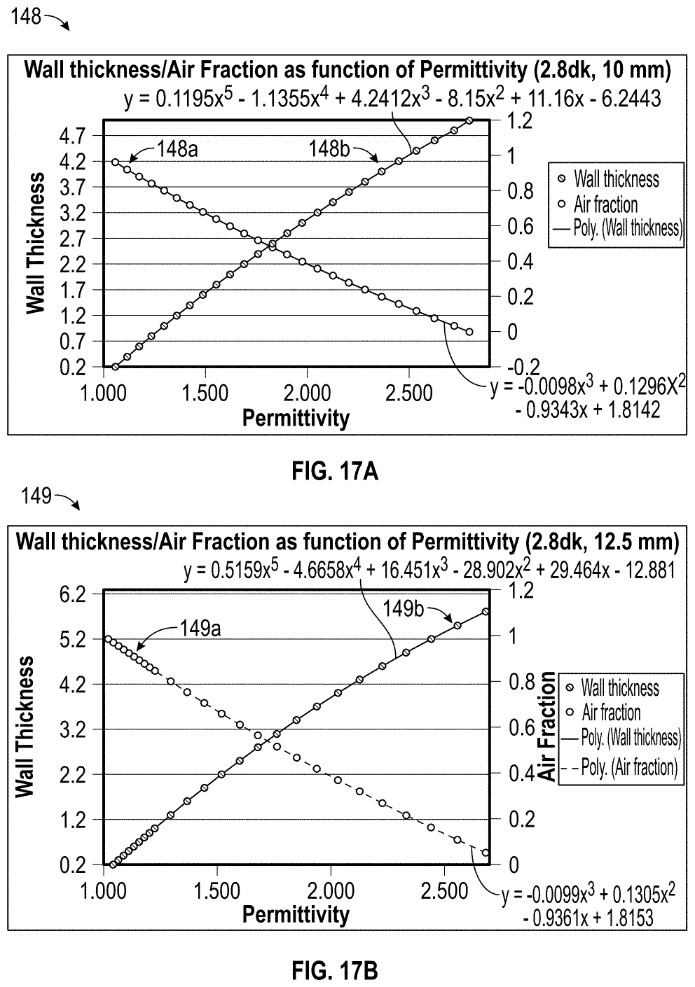

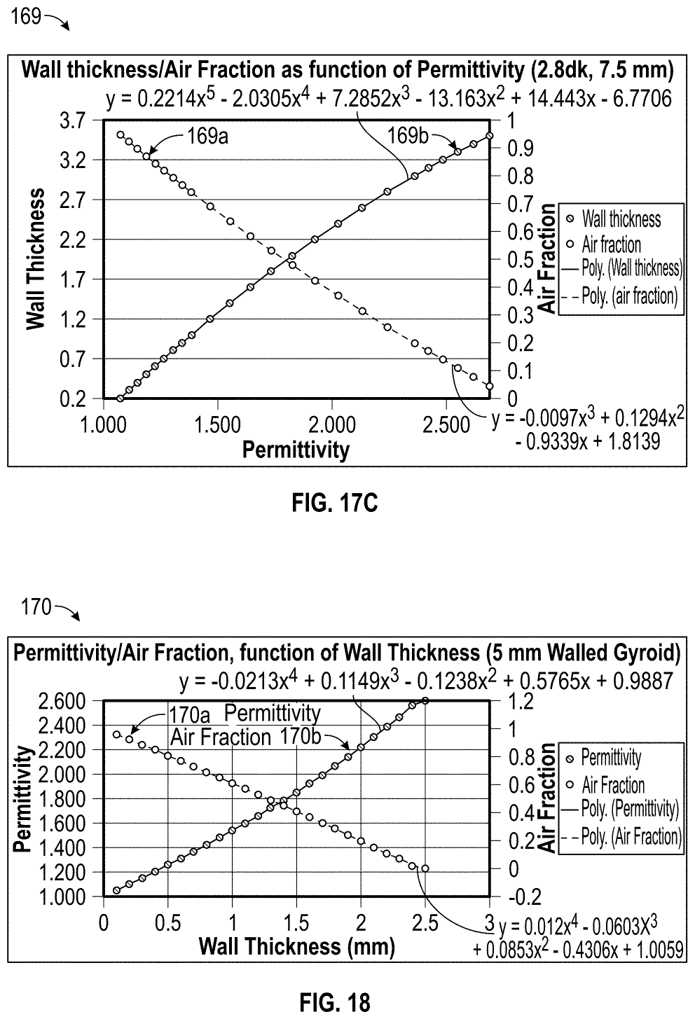

Related to the step 516 of the workflow 510, which involves converting the volume fraction of air to wall thickness, FIGS. 17A-19 illustrated example graphs having plotted curves that correlate permittivity to wall thickness for a given unit cell type and size. As users input selections using the UI 120, these entries, in conjunction with a library of plotted curves that can be referenced by the software performing these functions, can inform how the wall thickness should change across the three-dimensions of each unit cell, as well as between neighboring unit cells to create a desired permittivity across the entire object to be printed (e.g., GRIN device). In each illustrated instance, trend line formulas are shown on the chart, helping to interpolate the values across the volume of the object to be printed. Alternatively, or additionally relevant data or other information (e.g., equations, like the polynomial equations provided in FIGS. 17A-19) may be provided in lieu of or in addition to a library of plotted curves.

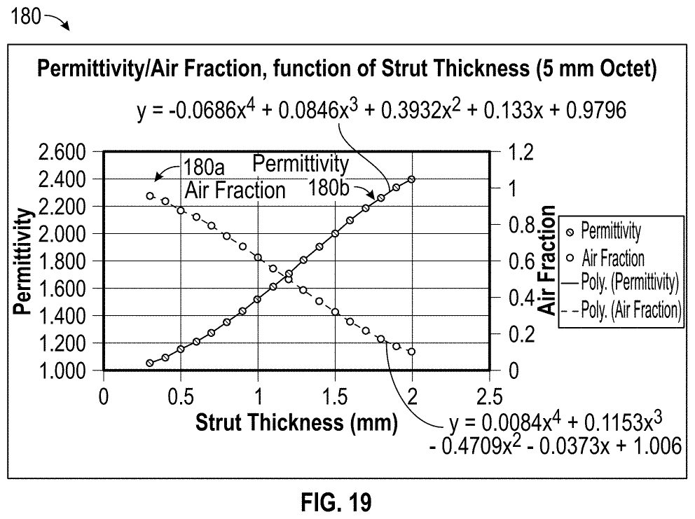

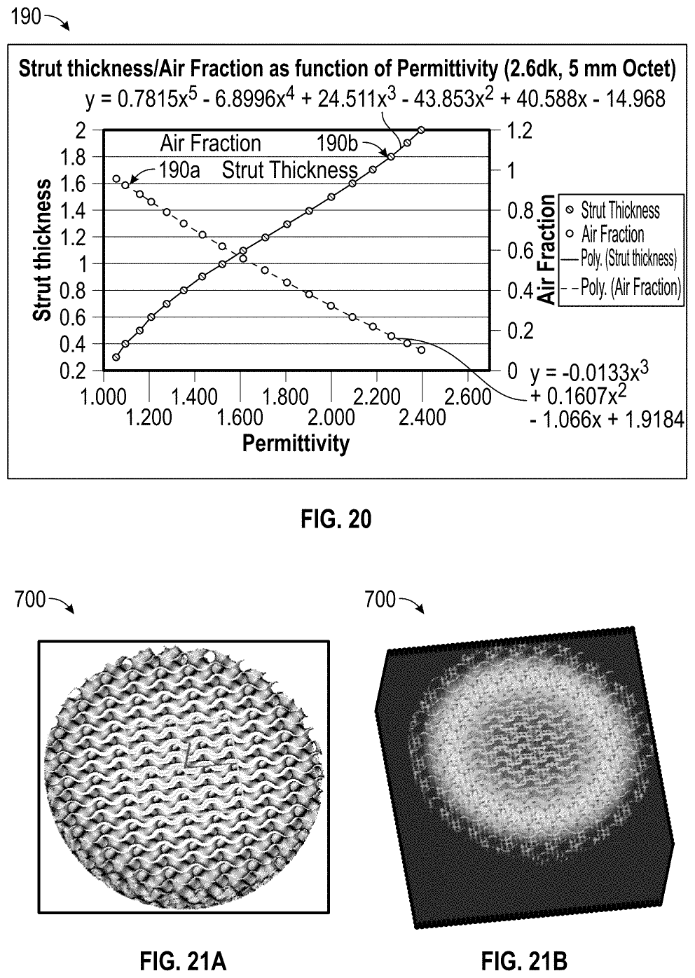

FIG. 17A shows graph 148 illustrating correlation curves 148a, 148b that correlate permittivity to wall thickness for a 10 mm cubic walled gyroid unit cell size that is to be printed using a material having a dielectric constant value of 2.8 dk. FIG. 17B shows graph 149 illustrating correlation curves 149a, 149b that correlate permittivity to wall thickness for a 12.5 mm cubic walled gyroid unit cell size that is to be printed using a material having a dielectric constant value of 2.8 dk. FIG. 17C shows graph 151 illustrating correlation curves 151a, 151b that correlate permittivity to wall thickness for a 7.5 mm cubic walled gyroid unit cell size that is to be printed using a material having a dielectric constant value of 2.8 dk. FIG. 18 shows graph 170 illustrating correlation curves 170a, 170b that correlate wall thickness to permittivity for a 5 mm cubic walled gyroid unit cell size. Although no material dielectric constant value is denoted, one can be provided. FIG. 19 shows graph 180 illustrating correlation curves 180a, 180b that correlate strut thickness to permittivity for a 5 mm cubic octet unit cell size. Again, although no material dielectric constant value is denoted, one can be provided. FIG. 20 shows graph 190 illustrating correlation curves 190a, 190b that correlate permittivity to strut thickness for a 5 mm cubit octet unit cell size that is to be printed using a material having a dielectric constant value of 2.6 dk. In each instance, the curves reflect the approximate inversely proportional relationship that exists between wall/strut thickness and air fraction and/or permittivity and air fraction. This make sense, as if a wall or strut is printed, then there is no air in that location, whereas where no print occurs, then air is present.

A person skilled in the art, in view of the present disclosures, will understand how to create graphs and correlation curves of this nature for a variety of different unit cell types and/or sizes. A detailed accounting of each graph and correlation curve for each unit cell type and/or size is thus unnecessary to support implementation of the same in a printing method or for use of an AM system that utilizes the techniques disclosed herein.

More generally, the interpolation and determination techniques provided for above can utilize a software such as Fortify Compass to process unstructured DK fields to solve for the density and/or strut thickness of each unit cell, allowing for smooth transitions of these values from unit cell to unit cell using linear interpolation, as described and illustrated above with respect to FIGS. 13A-13D.

To achieve the required volume fraction, the geometry configuration needs to be determined. This relationship can be dependent, for example, at least in part, on the selected unit cell geometry and/or the material used to print. Further, strut-and-node style lattice struts can be thickened or thinned to modify the local volume fraction. In the case of a strut-and-node style unit cell like the Octet, the strut thickness of every strut can be controlled uniformly within the cell to modulate the volume fraction. As the size of the strut increases, the volume fraction of air within the unit cell decreases. In a similar way in which the Octet strut-and-node style lattice struts can be thickened or thinned to modify the local volume fraction, the features (surface) of the TPMS design can be controlled in the same way. However, rather than controlling the thickness of a strut, the TPMS structure local density can be controlled by thickening or thinning the walls of the structure. For a given unit cell size, e.g., 5 mm octet, the relationship between the volume fraction of air and wall/strut thickness, as well as permittivity, can be expressed by a polynomial equation, such as the polynomial equations shown in each of FIGS. 17A-20. More particularly, in each graph, a polynomial equation is provided for each line that reflects a best-fit line for the plotted data, that best-fit line also being illustrated in each graph. The polynomial equations for each figure are as follows:
FIG. 17A, Wall Thickness:

y=0.1195x⁵−1.1355x⁴+4.2412x³−8.15x²+11.16x−6.2443
FIG. 17A, Air Fraction:

y=−0.0098x³+0.1296x²−0.9343x+1.8142
FIG. 17B, Wall Thickness:

y=0.5159x⁵−4.6658x⁴+16.451x³−28.902x²+29.464x−12.881

FIG. 17B, Air Fraction:

y=−0.0099x³+0.1305x²−0.9361x+1.8153
FIG. 17C, Wall Thickness:

y=0.2214x⁵−2.0305x⁴+7.2852x³−13.163x²+14.443x−6.7706
FIG. 17C, Air Fraction:

y=−0.0097x³+0.1294x²−0.9339x+1.8139
FIG. 18, Permittivity:

y=−0.0213x⁴+0.1149x³−0.1238x²+0.5765x+0.9887
FIG. 18, Air Fraction:

y=0.912x⁴−0.0603x³+0.0853x²−0.4306x+1.0059
FIG. 19, Permittivity:

y=−0.0686x⁴+0.0846x³+03.932x²+0.133x+0.9796
FIG. 19, Air Fraction:

y=0.0084x⁴+0.1153x³−0.4709x²−0.0373x+1.006
FIG. 20, Strut Thickness:

y=0.7815x⁵−6.8996x⁴+24.511x³−43.853x²+40.588x−14.968
FIG. 20, Air Fraction:

y=−0.0133x³+0.1607x²−1.066x+1.9184

A person skilled in the art, in view of the present disclosures, will understand how to arrive at the polynomial equations for various scenarios. The illustrated polynomial equations are merely examples, and are by no means limiting. A detailed accounting of other polynomials is thus unnecessary to support implementation of the same in a printing method or for use of an AM system that utilizes the techniques disclosed herein.

All of the above-described actions related to the step 514, converting RF data (e.g., dielectric constant values in three-dimensional space) to volume fraction of air, and the step 516, converting volume fraction of air to wall thickness, can more broadly be considered non-limiting ways by which RF inputs can be converted to one or more geometric-defining property values. These geometric-defining property values include, but are not limited to, volume fraction of air, wall thickness, strut thickness, and/or unit cell density, among others disclosed herein or otherwise understood by those skilled in the art in view of the present disclosures.

Action: Use Geometry Design Data

After converting RF data to volume fraction, for example using Equation 5, and later converting volume fraction to wall thickness, for example using exemplary graphs of FIGS. 17A-20 and/or related polynomial equations, the workflow 510 of FIG. 11B can use geometry design data to create a desired device/model at action or step 518. At step 518, the permittivity point cloud can be converted to a wall thickness point cloud, for instance by using the trend lines (e.g., the polynomial equations) and/or relationships described above. As a result, each point can now define a wall thickness.

FIG. 21A is a perspective cross section view of lens geometry design 700. FIG. 21B is the prospective view of the lens geometry design 700 having point cloud data 702 overlaid thereon. Similar to other embodiments, the point cloud data can be color coded based on wall thickness, for example. In the illustrated embodiment, the lens design 700 is made of a walled gyroid unit cells that are 10 mm unit cells each having 100 mm diameter. The data type in the illustrated embodiment is point cloud, though other data types are possible.

By combining the information extracted, interpolated, or otherwise determined from the RF type data of step 512, and subsequently transformed in steps 514 and 516, with the geometric design data associated with the step 518, one or more geometric-defining property values can be determined across a volume of a planned RF device to be printed. By way of non-limiting example, as provided for herein, in view of the permittivity determinations made across a volume of the planned RF device, unit cell constructions, and more generally build file determinations, can be determined for any location with the volume of the planned RF device.

A person skilled in the art, in view of the present disclosures, will appreciate that the geometry design data utilized can be merely information inputted by a user, or otherwise obtained by a user and/or the system, and subsequently applied with the other information described above to help define the build file. As explained above, this can all be performed without having to generate a CAD file or the like, which affords benefits related to computer power, speed, efficiency, and accuracy, among other benefits articulated herein or otherwise appreciated by a person skilled in the art in view of the present disclosures.

Action: Generate Support for 3D Structure

Turning back to the workflow 510 of FIG. 11B, it can be advantageous to account for printing out or otherwise providing and/or obtaining support structures upon which the desired structure, e.g., lens, can be built. This action or step 520 is illustrated to help in planning the print job because typically support structures are printed in conjunction with the larger print job, although a person skilled in the art will appreciate the support structures can be generated or otherwise obtained at any time in the process of the workflow 510 prior to printing the intended device itself. FIG. 22A is a perspective view of a plurality of support structures 1090 for supporting a lens 1080 (FIG. 22B) to be printed. The support structures 1090 can extend, from example, from a build plate 1020 (FIG. 22B), and, as shown, can become thinner as they extend from their base or proximal portions 1090b located at the build plate 1020 to their tip or distal portions 1090t. Thus, as shown, each support structure 1090 is typically wider at the base portion 1090b than at the tip portion 1090t of the support structure 1090. With that said, at least some tip portions 1090t can also including a receiving portion 1090r that can be wider than the tip portion 1090t, and often wider than the base portion 1090b, for helping to support an object to be printed, such as the GRIN lens 1080 (FIG. 22B). The receiving portions 1090r provide multiple connection points for the object to be printed to connect to a single support structure 1090.

FIG. 22B is a perspective view of the support structures 1090 with the lens 1080 connected thereto. As shown, there are a plurality of connection points between the support structures 1090 and the lens 1080. The connection points can include the receiving portions 1090r and/or can include the top portion 1090t connecting directly to the lens 1080. The support structures 1090 can extend from a common location, for example a build plate 1020 of an AM device, such as a DLP printer. A person skilled in the art will understand a variety of different AM techniques that can be used in conjunction with the present disclosures. In some exemplary embodiments, the AM technique utilized can be a DLP, bottom-up printer 1000′ illustrated in FIGS. 22C-22E.

With the understanding that a person skilled in the art will understand how many of the components of the printer 1000′ operate, the discussion herein is directed only to some aspects of the printer 1000′ that perform the printing itself—as shown in FIG. 22D a build plate 1020′, a reservoir 1030′ having a film or resin disposed therein, and a light source 1040′ (e.g., a digital light projector) that can be used to selectively cure the film 1032′ to produce the printed object as the build plate 1020′ moves away from the reservoir 1030′, for example vertically, or upwards, along or with respect to a Z-axis 1050′, or substantially parallel to the Z-axis 1050′. For purposes of this disclosure, it is not necessary to describe how the build plate 1020′ is moved and/or how the light source 1040′ performs the curing, as aspects of this nature are known to those skilled in the art and are incorporated by reference herein earlier in the description. Accordingly, while FIG. 22B illustrates the build plate 1020 below the lens 1080, in a bottom-up print design like the printer 1000′, in practice the build plate 1020′ can be disposed above a printed lens 1080′, with the film becoming connected to the build plate 1020′ to form support structures 1090′ and then the lens 1080′ as the build plate 1020′ moves vertically away from the reservoir 1030′ and the light source 1040′ is used to cure the film to create the desired print (e.g., the support structures 1090′ and lens 1080′). Thus, the illustration of FIG. 22B can be utilized in a bottom-up print design even though is shows the build plate 1020 below the lens 1080.

FIG. 22E illustrates that a plurality of lens 1080′ can be printed simultaneously using the printer 1000′. As shown, extending from the build plate 1020′ is a plurality of support structures 1090′ and lens 1080′ formed using the techniques provided for herein. Additional details about how the printing is performed can be found in the white paper entitled “3D Printed Dielectric Lenses Increase Antenna Gain and Widen Beam Scanning Angle,” which can be downloaded at https://3dfortify.com/wp-content/uploads/2021/07/Fortify_3D-Printed-Dielectric-Lenses-White-Paper_RevB.pdf, the contents of which is incorporated herein in its entirety.

A person skilled in the art will appreciate that while the present disclosure includes teachings related to a bottom-up DLP printing technique and related printer(s), many types of 3D printing (e.g., SLA, DLP, LCD, among others) and 3D printers can be utilized (e.g., top-down DLP printer, as well as other DLP and non-DLP printers) in taking advantage of the disclosures provided for herein for printing structures like GRIN devices. Accordingly, this disclosure is not limited to a single type of printing, and a person skilled in the art, in view of the present disclosures, will understand how to apply the principles disclosed herein to other types of AM to produce GRIN devices and the like.

Action: Built Layout and Create Slices

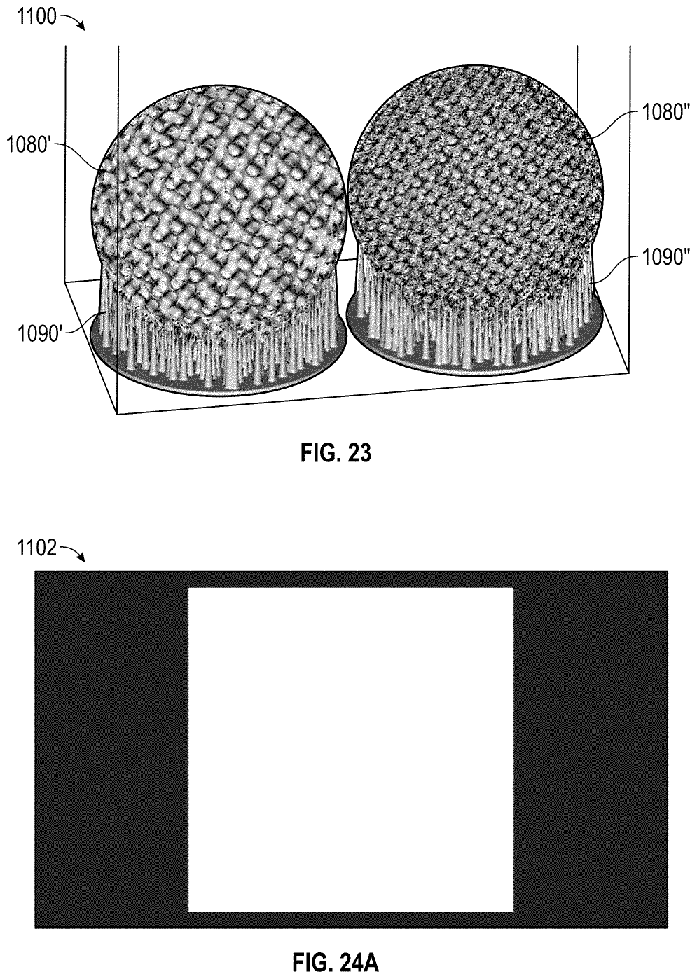

The workflow 510 of FIG. 11B also provides for building a layout, at action or step 522. This entails creating the build file based, at least in part, on the RF lens design data and the geometry design data. Software, such as the aforementioned Compass software, can compile the desired RF and design properties and put it together in a build file without passing that information through a CAD file. The resulting image 1100 can be what is illustrated in FIG. 23. As shown, the build file can account for a plurality of lenses 1080, 1080″ to be printed, with each lens not necessarily having to have the same design (e.g., different unit cells, geometries, boundaries, etc., such options being described herein and/or known to those skilled in the art in view of the present disclosures), though they could have the same design. In the illustrated embodiment the lens 1080 and support structures 1090 of FIG. 22B is shown on a left side of the image and the lens 1080″, along with support structures 1090″ to support the same, are shown on a right side of the image.

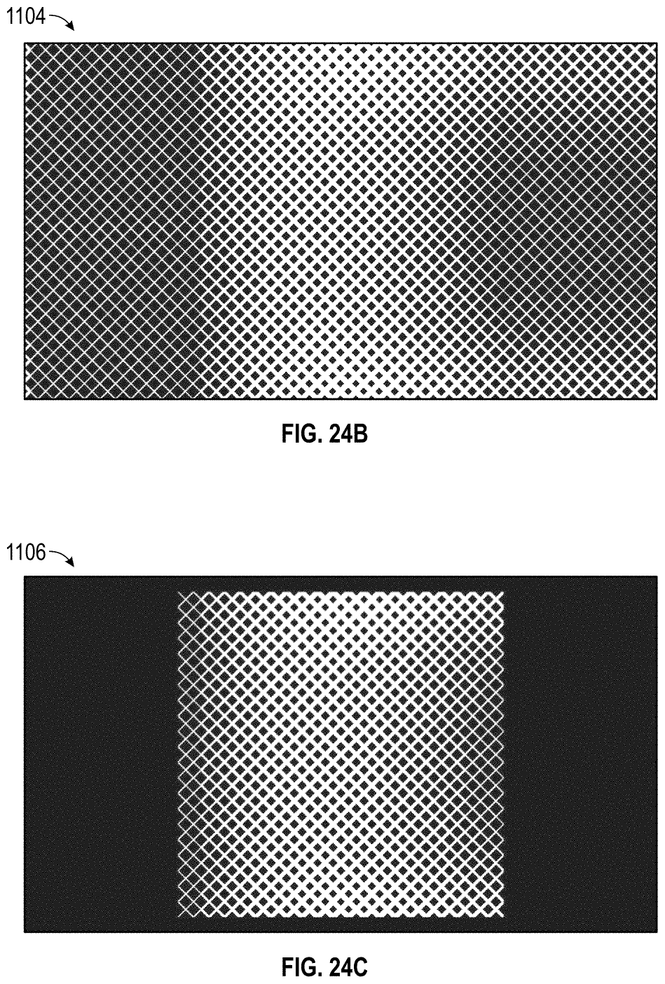

After the build has been laid out, it can be subsequently formed into individual slice images for purposes of determining how each layer will be built during the AM process. This is accounted for in action or step 524 of the workflow of FIG. 11B, and is illustrated in FIG. 24. More particularly, the software (e.g., Compass software) steps through the z-axis of the build design at designated layer height intervals and creates a .png file for every layer. In order to perform this process without generating a polygon mesh to define the latticed geometry and/or boundary representation model (e.g., CAD files, such as .STL, .STEP, .3MF, AMF, and .IGES files), the software can combine solid layer slices of the boundary geometry with a layer mask of the internal lattice geometry. The present disclosures allow for design data to be converted directly to an image (e.g., .PNG file) for each layer to be printed. Instead of generating a complex 3D model like is done with polygon meshes and/or boundary representation models, only the layers that will be printed are generated as part of the build file, such layers being generated directly from design data.

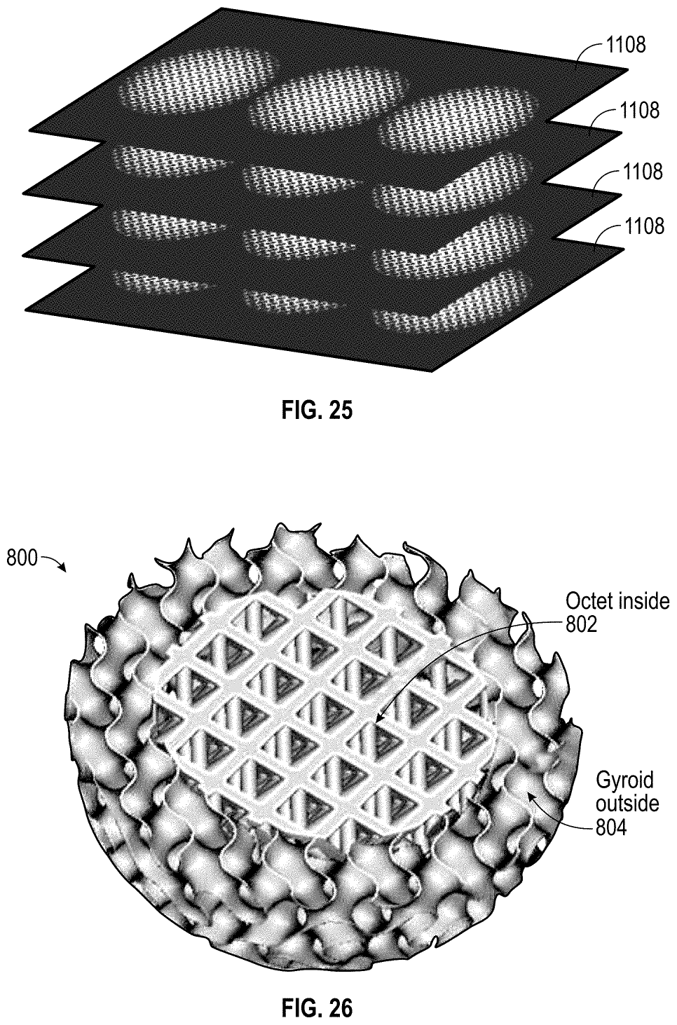

FIGS. 24A-24C illustrate a way by which layer masks can be created to form a build file. The software can first create fully solid slices (e.g., in .PNG) based on the bounding .STL geometry, in the same way it slices a normal, non-latticed part. An example of such an image 1102 is provided in FIG. 24A. Using the unit cell parameters selected by the user, processed Dk field, and/or the implicit equations for a unit cell as defined by example Equation 1 and example Equation 2, the software can then create a set of layer masks that can describe the lattice geometry independent of the bounding geometry. An example of such an image 1104 is provided in FIG. 24B. These layer masks can include lattice geometry information for each layer slice, such information including but not limited to a unit cell size, a unit cell type, a grid phase, and/or a density from a dielectric constant input. A person skilled in the art will understand a grid phase can include a translation of the unit cells in x, y, and z planes relative to a bulk boundary geometry. The software can then apply Boolean layer masks to the solid slices to produce final slices of a latticed cross-section of the bounding geometry. An example of such an image 1106 is provided in FIG. 24C. FIG. 25 illustrates what a plurality of slice images 1108 may look like for a print job. While the illustrated embodiment includes four slices 1108, in practice typically more slices are used, including hundreds, thousands, or even more. Each slice 1108 can be a two-dimensional black-and-white image that is fed to a light projector, which can be used to instruct the projector which pixels should be turned on and off for each respective layer to print the desired object.

Action: Build Structure

The last action or step of the workflow 510 of FIG. 11B is to build the structure, also referred to as the desired object, among other terms. The print job can commence once one or more (often, but not necessarily all) of the slices have been generated by the software. Other software can also be used in lieu or in addition to the reference Compass software, such as an nTopology Platform CAD design software product. This software can allow for the user to define a boundary and populate that boundary with a structure like a strut-and-node lattice or TPMS. The nTopology Platform CAD design software product, however, generates a CAD file, and can export it as a .STEP or mesh (.STL) file, meaning the product is not as useful because the file sizes it creates can be large and unmanageable, resulting in undesirably high memory usage while processing, undesirably high usage of power to process, and taking undesirably long amounts of time to process, among other drawbacks current systems have that are described herein and/or appreciated by those skilled in the art. In some embodiments, the print or build file that is generated can be exported to be printed, such as to a 3D printer. The build file can include slice images, among other information provided for herein or otherwise known to those skilled in the art. In other embodiments, no export is needed because the build file is generated by the 3D printer that will print the file.

The present disclosure also provides alternative embodiments to print 3D structures that use multiple unit cell geometries within a single lens design. For instance, a designer/user can use a base geometry of a node-and-strut type at the core of a device and transition to a TPMS structure or another strut-and-node structure for the surface regions of the device that is less prone to the creation of thin struts. This can create interesting opportunities to combine a variety of unit cell geometries to create novel structures with the purpose of solving an engineering challenge like ease of manufacturing, ease of cleaning, robustness in the application, and/or some other unmentioned metric(s). FIG. 25 shows one non-limiting exemplary structure of these alternatives which a lens geometry design 800 includes an octet strut and node structure 802 inside and a gyroid TPMS structure 804 outside.

There is also a possibility to include several TPMS structures within a single lens or GRIN device. One of the advantages can be to leverage the unique advantage of a specific unit cell at the core of the device, while another may be better suited for the surface region. For instance, in a design that each unit cell can have a different relative density, it can be possible to select one unit cell due to a lower density for the core, while leveraging a higher relative density unit cell towards the surface (or vice versa).

In another alternative, illustrated with respect to FIGS. 26-26B, cantilever surface beams of a node-and-strut design can be reinforced with conformal beam members. In this design, a generative design tool can be used to identify the position of trimmed unit cells where cantilever beams can be created and can generate a series of conformal members that tie together these beams. This can be accomplished without violating the critical outer boundary of the device, like the spherical boundary of the Luneburg Lens. FIG. 26A shows an octet strut and node lens geometry design 806 and a conformal beams strut and node lens geometry design 808. FIG. 26B shows these two designs 806 and 808 combined to create a lens geometry 810. The octet strut and node lend geometry design 806 is on an inside and the conformal beams strut and node lens geometry design 808 is on an outside of the resulting design 810.

The printing methodologies provided for herein, as well as the implementation of TPMS structure as the base unit for a GRIN device, provides the device with a higher level of structural integrity and strength. These disclosures can be implemented across devices of a variety of sizes, such sizes being understood by a person skilled in the art in view of the present disclosures and knowledge of the skilled person. For example, a person skilled in the art will appreciate various options for sizing a GRIN device, including but not limited to the diameters and volumes identified herein, as well as other values above and below those values and/or adapted for other, non-spherical configurations. For example, the device can be used in applications where the user is looking to apply GRIN technology. This might be in a RADAR device, in a 5G mmWave antenna, and/or in a SATCOM antenna, among other uses. It is also possible to apply GRIN technology to radio frequency substrates, impedance-matching surfaces, and dielectric waveguides, among other uses.

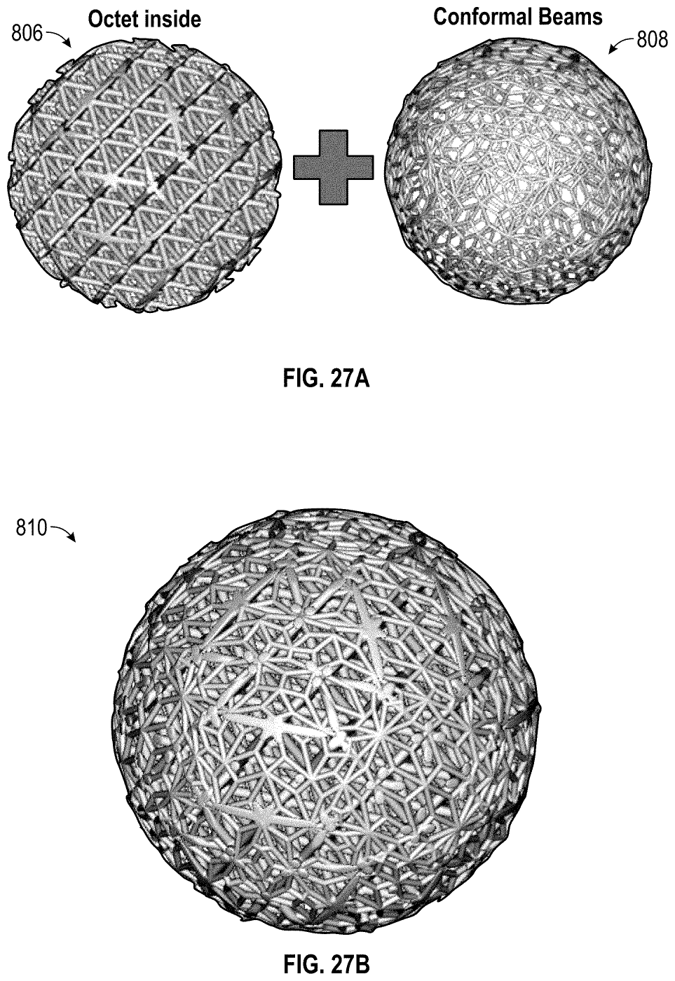

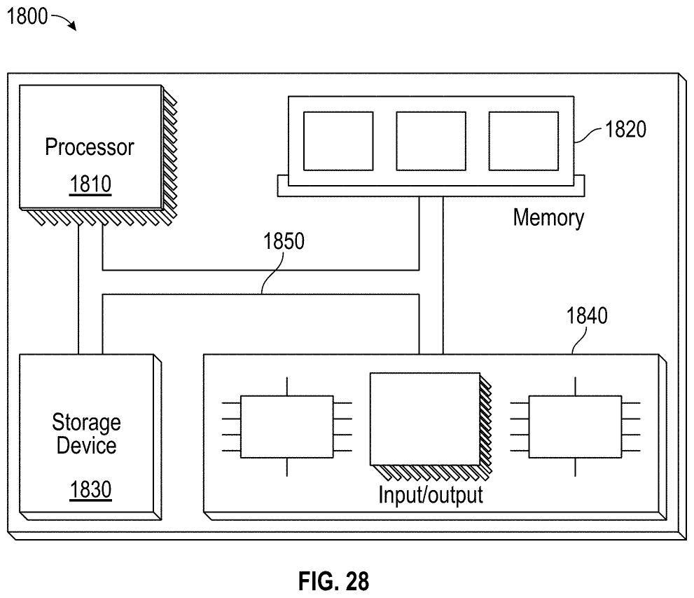

FIG. 27 provides for one non-limiting example of a computer system 1800 upon which actions, provided for in the present disclosure, including but not limited to the techniques for generating a build file and/or using the same to perform a print job with an AM device, can be built, performed, trained, etc. The system 1800 can include a processor 1810, a memory 1820, a storage device 1830, and an input/output device 1840. Each of the components 1810, 1820, 1830, and 1840 can be interconnected, for example, using a system bus 1850. The processor 1810 can be capable of processing instructions for execution within the system 1800. The processor 1810 can be a single-threaded processor, a multi-threaded processor, or similar device. The processor 1810 can be capable of processing instructions stored in the memory 1820 or on the storage device 1830. The processor 1810 may execute operations such as generating build files and/or executing the software (e.g., Compass software), among other features described in conjunction with the present disclosure.

The memory 1820 can store information within the system 1800. In some implementations, the memory 1820 can be a computer-readable medium. The memory 1820 can, for example, be a volatile memory unit or a non-volatile memory unit. In some implementations, the memory 1820 can store information related to the instructions for manufacturing GRIN devices, among other information.

The storage device 1830 can be capable of providing mass storage for the system 1800. In some implementations, the storage device 1830 can be a non-transitory computer-readable medium. The storage device 1830 can include, for example, a hard disk device, an optical disk device, a solid-date drive, a flash drive, magnetic tape, or some other large capacity storage device. The storage device 1830 may alternatively be a cloud storage device, e.g., a logical storage device including multiple physical storage devices distributed on a network and accessed using a network. In some implementations, the information stored on the memory 1820 can also or instead be stored on the storage device 1830.

The input/output device 1840 can provide input/output operations for the system 1800. In some implementations, the input/output device 1840 can include one or more of network interface devices (e.g., an Ethernet card), a serial communication device (e.g., an RS-232 10 port), and/or a wireless interface device (e.g., a short-range wireless communication device, an 802.11 card, a 3G wireless modem, a 4G wireless modem, or a 5G wireless modem). In some implementations, the input/output device 1840 can include driver devices configured to receive input data and send output data to other input/output devices, e.g., a keyboard, a printer, and display devices (such as the GUI 12). In some implementations, mobile computing devices, mobile communication devices, and other devices can be used.

In some implementations, the system 1800 can be a microcontroller. A microcontroller is a device that contains multiple elements of a computer system in a single electronics package. For example, the single electronics package could contain the processor 1810, the memory 1820, the storage device 1830, and input/output devices 1840.

The present disclosure also accounts for providing a non-transient computer readable medium capable of storing instructions. The instructions, when executed by a computer system like the system 1800, can cause the system 1800 to perform the various functions and methods described herein for printing, forming build files, etc.

Some non-limiting examples of the above-described embodiments can include the following:
1. A method of at least one of designing or manufacturing a radio frequency (RF) device by way of additive manufacturing, comprising:

receiving a plurality of inputs, the inputs comprising:
a plurality of RF inputs; and
at least one of:
   a desired boundary shape of a planned RF device to be printed;
   a selection of one or more materials for printing; or
   a selection of one or more unit cells to be generated when printing;

converting the plurality of RF inputs to one or more geometric-defining property values; and

determining one or more geometric-defining property values across a volume of the planned RF device to be printed.
2. The method of claim 1, wherein the plurality of RF inputs comprise a plurality of dielectric constant values in three-dimensional space.
3. The method of claim 2, wherein no bounding geometry is utilized in conjunction with the plurality of dielectric constant values in three-dimensional space.
4. The method of claim 2 or 3, wherein no lattice is graphically rendered from the plurality of dielectric constant values in three-dimensional space.
5. The method of any of claims 1 to 4, wherein the one or more geometric-defining property values comprises at least one of a unit cell density, a wall thickness, or a strut thickness.
6. The method of any of claims 1 to 5, wherein determining one or more geometric-defining property values across a volume of a planned RF device to be printed comprises:

creating a gradient of the one or more geometric-defining property values across a volume of a planned RF device to be printed.
7. The method of any of claims 1 to 6, wherein determining one or more geometric-defining property values across a volume of a planned RF device to be printed comprises:

interpolating the one or more geometric-defining property values for each unit cell, or part thereof, of the planned RF device to be printed.
8. The method of any of claims 1 to 6, wherein determining one or more geometric-defining property values across a volume of a planned RF device to be printed comprises:

identifying a nearest data value to each unit cell; and

assigning, based on the identified nearest data value, the one or more geometric-defining property values for each unit cell, or part thereof, of the planned RF device to be printed.
9. The method of claim 1, further comprising:

generating each layer slice for printing the planned RF device to be printed.
10. The method of claim 9, further comprising:

exporting a print file that includes each layer slice for printing the planned RF device to be printed.
11. The method of any of claims 1 to 10, further comprising:

printing the planned RF device to be printed.
12. The method of any of claims 1 to 11, further comprising at least one of:

performing a radio frequency simulation to obtain the plurality of RF inputs; or

using one or more equations to determine the plurality of RF inputs.
13. The method of any of claims 1 to 12, wherein the plurality of RF input comprise:

a plurality of shells, the shells having different permittivity values;

a point cloud of RF data points, the RF data points having different permittivity values across the cloud; or

values derived from one or more equations to determine permittivity values, the permittivity values differing across a provided geometry.
14. The method of any of claims 1 to 13, wherein the actions are performed without generating a mesh.
15. The method of claim 14, wherein the mesh comprises a CAD file.
16. The method of claim 15, wherein the CAD file comprises at least one of an .STL file, a .STEP file, a .3MF file, an .AMF file, or an .IGES file.
17. A method of at least one of designing or manufacturing a radio frequency (RF) device, comprising:

receiving a plurality of inputs, the inputs comprising:
a plurality of RF inputs; and
at least one of:
   a desired boundary solid geometry;
   a selection of one or more materials for printing; or
   a selection of one or more unit cells to be generated when printing;

determining at least one of a density or a strut thickness for each unit cell, or part thereof, of a planned RF device to be printed;

creating a set of layer masks that include lattice geometry information for each layer slice of the planned RF device to be printed based on the determined at least one of a density or a strut thickness for each unit cell, or part thereof, of a planned RF device to be printed; and

slicing a boundary solid geometry and combining at least some portion of the set of layer masks to the sliced boundary solid geometry to create a final slice to be printed.
18. The method of claim 17, wherein the lattice geometry information for each layer slice of the planned RF device to be printed comprises at least one of: unit cell size, unit cell type, a grid phase, or density from a dielectric constant input.
19. The method of claim 17 or 18, further comprising:

exporting a print file that includes each layer slice for printing the planned RF device to be printed.
20. The method of any of claims 17 to 19, further comprising:

printing the planned RF device to be printed.
21. The method of any of claims 17 to 20, further comprising at least one of:

performing a radio frequency simulation to obtain the plurality of RF inputs; or

using one or more equations to determine the plurality of RF inputs.
22. The method of any of claims 17 to 21, wherein the plurality of RF input comprise:

a plurality of shells, the shells having different permittivity values;

a point cloud of RF data points, the RF data points having different permittivity values across the cloud; or

values derived from one or more equations to determine permittivity values, the permittivity values differing across a provided geometry.
23. The method of any of claims 17 to 22, wherein the actions are performed without generating a mesh.
24. The method of claim 23, wherein the mesh comprises a CAD file.
25. The method of claim 24, wherein the CAD file comprises at least one of an .STL file, a .STEP file, a .3MF file, an .AMF file, or an .IGES file.
26. A method of at least one of designing or manufacturing a radio frequency (RF) device, comprising:

receiving a plurality of design inputs for an RF device to be printed, the inputs comprising at least two of:
a desired design type;
a weight;
a boundary;
a size;
an aperture size;
a gain;
a frequency of operation; or
a focal distance from a surface to a center;

suggesting a design output for the RF device to be printed based at least on the received plurality of design inputs.
27. The method of claim 26, wherein the desired design type comprises at least one of a Luneburg lens, a Luneburg-style lens, or a Gutman lens.
28. The method of claim 26 or 27, wherein the design output comprises at least one of:

a dielectric constant distribution;

at least one of a lattice structure selection or a triply periodic minimal surface (TPMS) structure selection; or

one or more support structures.
29. The method of claims 28, wherein the design output further comprises at least one of:

a device size; or

a device boundary.
30. The method of any of claims 26 to 29, wherein the actions are performed without obtaining RF inputs.
31. The method of any of claims 26 to 30, wherein the actions are performed without generating a mesh.
32. The method of claim 31, wherein the mesh comprises a CAD file.
33. The method of claim 32, wherein the CAD file comprises at least one of an .STL file, a .STEP file, a .3MF file, an .AMF file, or an .IGES file.
34. A gradient refractive index (GRIN) device, comprising:

a plurality of triply periodic minimal surface (TPMS) constructs; and

one or more materials having a tailored dielectric constant.
35. The device of claim 34, wherein the plurality of TPMS constructs further comprise one or more gyroids.
36. The device of claim 34 or 35, wherein the plurality of TPMS constructs form a plurality of unit cells.
37. The device of any of claims 34 to 36, wherein a wall thickness of at least one TPMS construct of the plurality of TPMS constructs has a changing thickness across its length.
38. The device of any of claims 34 to 37, wherein a wall thickness of the plurality of TPMS constructs changes across a length of the GRIN device.
39. The device of any of claims 34 to 38, wherein the GRIN device comprises a lens.
40. A method of manufacturing a gradient refractive index (GRIN) device, comprising:

forming a plurality of triply periodic minimal surface (TPMS) constructs from one or more materials to form a GRIN device having a tailored dielectric constant throughout its volume.
41. The method of claim 40, further comprising controlling a thickness of one or more walls of the plurality of TPMS constructs to control a density of the plurality of TPMS constructs.
42. The method of claim 41,

wherein the plurality of TPMS constructs form a plurality of unit cells, and

wherein controlling a thickness of one or more walls of the plurality of TPMS constructs controls a density of the plurality of unit cells.
43. The method of claim 41 or 42, further comprising:

comparing parameters in at least one of an x, y, or z position in Cartesian space within at least one of the plurality of TPMS constructs or the plurality of unit cells with a pre-determined coefficient based on a desired density of at least one of the plurality of TPMS constructs or the plurality of unit cells.
44. The method of claim 43, further comprising determining the pre-determined coefficient by:

generating a collection of at least one of TPMS constructs or unit cells within a range of coefficient values;

calculating a density as volume of solid divided by total volume for each at least one of TPMS constructs or unit cells within a range of coefficient values of the collection; and

using the calculated densities in a piecewise linear interpolation equation to compare any desired density against.

One skilled in the art will appreciate further features and advantages of the present disclosure based on the above-described embodiments. Accordingly, the disclosure is not to be limited by what has been particularly shown and described, except as indicated by the appended claims. Further, a person skilled in the art, in view of the present disclosures, will understand how to implement the disclosed systems and methods provided for herein in conjunction with DLP-style additive manufacturing printers. All publications and references cited herein are expressly incorporated herein by reference in their entireties.

In the foregoing detailed description, numerous specific details are set forth by way of examples in order to provide a thorough understanding of the relevant teachings. However, it should be apparent to those skilled in the art that the present teachings may be practiced without such details. In other instances, well-known methods, procedures, components, and/or circuitry have been described at a relatively high-level, without detail, in order to avoid unnecessarily obscuring aspects of the present disclosure. While this disclosure includes a number of embodiments in many different forms, there is shown in the drawings and will herein be described in detail particular embodiments with the understanding that the present disclosure is to be considered as an exemplification of the principles of the disclosed methods and systems, and is not intended to limit the broad aspects of the disclosed concepts to the embodiments illustrated. As will be realized, the subject technology is capable of other and different configurations, several details are capable of modification in various respects, embodiments may be combined, and steps in the flow charts may be omitted or performed in a different order, all without departing from the scope of the subject technology. Accordingly, the drawings, flow charts, and detailed description are to be regarded as illustrative in nature and not as restrictive.

1. A method of at least one of designing or manufacturing a radio frequency (RF) device by way of additive manufacturing, comprising:
receiving a plurality of inputs, the inputs comprising:
a plurality of RF inputs; and
at least one of:
a desired boundary shape of a planned RF device to be printed;
a selection of one or more materials for printing; or
a selection of one or more unit cells to be generated when printing;
converting the plurality of RF inputs to one or more geometric-defining property values; and
determining one or more geometric-defining property values across a volume of the planned RF device to be printed.

2. The method of claim 1, wherein the plurality of RF inputs comprise a plurality of dielectric constant values in three-dimensional space.

3. The method of claim 2, wherein no bounding geometry is utilized in conjunction with the plurality of dielectric constant values in three-dimensional space.

4. The method of claim 2, wherein no lattice is graphically rendered from the plurality of dielectric constant values in three-dimensional space.

5. The method of claim 1, wherein the one or more geometric-defining property values comprises at least one of a unit cell density, a wall thickness, or a strut thickness.

6. The method of claim 1, wherein determining one or more geometric-defining property values across a volume of a planned RF device to be printed comprises:
creating a gradient of the one or more geometric-defining property values across a volume of a planned RF device to be printed.

7-11. (canceled)

12. The method of claim 1, further comprising at least one of:
performing a radio frequency simulation to obtain the plurality of RF inputs; or
using one or more equations to determine the plurality of RF inputs.

13. The method of claim 1, wherein the plurality of RF input comprise:
a plurality of shells, the shells having different permittivity values;
a point cloud of RF data points, the RF data points having different permittivity values across the cloud; or
values derived from one or more equations to determine permittivity values, the permittivity values differing across a provided geometry.

14. The method of claim 1, wherein the actions are performed without generating a mesh.

15. The method of claim 14, wherein the mesh comprises a CAD file.

16. (canceled)

17. A method of at least one of designing or manufacturing a radio frequency (RF) device, comprising:
receiving a plurality of inputs, the inputs comprising:
a plurality of RF inputs; and
at least one of:
a desired boundary solid geometry;
a selection of one or more materials for printing; or
a selection of one or more unit cells to be generated when printing;
determining at least one of a density or a strut thickness for each unit cell, or part thereof, of a planned RF device to be printed;
creating a set of layer masks that include lattice geometry information for each layer slice of the planned RF device to be printed based on the determined at least one of a density or a strut thickness for each unit cell, or part thereof, of a planned RF device to be printed; and
slicing a boundary solid geometry and combining at least some portion of the set of layer masks to the sliced boundary solid geometry to create a final slice to be printed.

18. The method of claim 17, wherein the lattice geometry information for each layer slice of the planned RF device to be printed comprises at least one of: unit cell size, unit cell type, a grid phase, or density from a dielectric constant input.

19. (canceled)

20. (canceled)

21. The method of claim 17, further comprising at least one of:
performing a radio frequency simulation to obtain the plurality of RF inputs; or
using one or more equations to determine the plurality of RF inputs.

22. The method of claim 17, wherein the plurality of RF input comprise:
a plurality of shells, the shells having different permittivity values;
a point cloud of RF data points, the RF data points having different permittivity values across the cloud; or
values derived from one or more equations to determine permittivity values, the permittivity values differing across a provided geometry.

23. The method of claim 17, wherein the actions are performed without generating a mesh.

24. The method of claim 23, wherein the mesh comprises a CAD file.

25-33. (canceled)

34. A gradient refractive index (GRIN) device, comprising:
a plurality of triply periodic minimal surface (TPMS) constructs; and
one or more materials having a tailored dielectric constant.

35. The device of claim 34, wherein the plurality of TPMS constructs further comprise one or more gyroids.

36. (canceled)

37. The device of claim 34, wherein a wall thickness of at least one TPMS construct of the plurality of TPMS constructs has a changing thickness across its length.

38. The device of claim 34, wherein a wall thickness of the plurality of TPMS constructs changes across a length of the GRIN device.

39-44. (canceled)
